(19) United States
(12) Patent Application Publication
(10) Pub. No.: US 2025/0147294 A1
(43) Pub. Date: May 8, 2025

(54) Systems and Methods for Hyperspectral Microscopy

(71) Applicant: The Board of Trustees of the University of Illinois, Urbana, IL (US)

(72) Inventors: Stephen A. Boppart, Urbana, IL (US); Janet Sorrells, Urbana, IL (US); Rishyashring Raman Iyer, Urbana, IL (US); Lingxiao Yang, Urbana, IL (US)

(21) Appl. No.: 18/939,226

(22) Filed: Nov. 6, 2024

Related U.S. Application Data
(60) Provisional application No. 63/596,554, filed on Nov. 6, 2023.

(51) Int. Cl. G02B 21/00; G01N 21/64; G01N 21/65

(52) U.S. Cl. CPC G02B 21/0032; G01N 21/6458; G02B 21/0036; G02B 21/0064; G01N 2021/655; G02B 21/0076

(57) ABSTRACT

Systems and methods of microscopy include and/or implement a laser configured to output a first beam and a second beam; a first optical system configured to receive the first beam, the first optical system comprising: a first beam splitter configured to split the first beam into a first component and a second component, a first photonic crystal fiber configured to modify a bandwidth of the first component, and a first pulse shaper configured to shape the first component in at least one of a spatial aspect or a temporal aspect, the first pulse shaper including a first diffraction grating, a first achromatic half-wave plate, a first lens, and a first two-dimensional spatial light modulator (SLM); and a second optical system configured to receive the second beam.

### CROSS-REFERENCE TO RELATED APPLICATIONS

This application claims priority to and the benefit of U.S. Provisional Patent Application No. 63/596,554, filed Nov. 6, 2023 and titled “Systems and Methods for Hyperspectral Microscopy,” the entire contents of which are herein incorporated by reference for all purposes.

### STATEMENT REGARDING FEDERALLY SPONSORED RESEARCH OR DEVELOPMENT

This invention was made with government support under P41EB031772 and T32EB019944 awarded by the National Institutes of Health (NIH). The government has certain rights in the invention.

### TECHNICAL FIELD

This disclosure relates to the field of microscopy. More particularly, this disclosure relates to optical systems and methods for hyperspectral microscopy, including but not limited to coherent anti-Stokes Raman scattering (CARS) microscopy.

### BACKGROUND

Coherent anti-Stokes Raman scattering (CARS) microscopy is a label-free optical imaging technique that provides chemical contrasts based on molecular vibrations. Arising from a third-order multiphoton light-matter interaction, the CARS signal is orders of magnitude stronger than that from spontaneous Raman scattering, and, thus, the signals can be acquired at higher speeds for microscopy. CARS employs near-infrared ultrashort excitation pulses that allow intrinsic optical sectioning and increased penetration depth, which enables thick tissue imaging for three-dimensional microscopy. The blue-shifted CARS signals can be separated from the excitation pulses and additional light-matter interactions such as fluorescence or harmonic generation using spectral filters. Developments in CARS have made the technique a tool for chemical, physical, and biological sciences for material characterization, biochemical profiling of the tissue microenvironment, disease diagnostics, and drug assessments.

### SUMMARY

Pulse shapers are optical devices used to control the temporal and/or spectral profile of laser pulses. In some hyperspectral imaging techniques, a pulse shaper may be used to modify the shape of pulsed lasers used to excite samples. The present disclosure provides an improved pulse shaper design that may be used in microscopy systems operating in a range of hyperspectral microscopy modalities.

Coherent anti-Stokes Raman scattering (CARS) microscopy offers label-free chemical contrasts through molecular vibrations. Hyperspectral CARS (HS-CARS) enables comprehensive microscale chemical characterization of biological samples. Various HS-CARS methods have been developed with individual advantages and disadvantages. The present disclosure sets forth a temporally- and spectrally-shaped (TSS) HS-CARS method to overcome the limitations of existing techniques and provide precise control of the spatial and temporal profiles for efficient and accurate measurements. This method uses Fourier transform pulse shaping (FTPS) based on a two-dimensional spatial light modulator (SLM). TSS-HS-CARS achieves fast, stable, and flexible acquisition, minimizes photodamage, and is highly adaptable to a multimodal multiphoton imaging system.

According to one example of the present disclosure, a pulse shaper is provided. The pulse shaper comprises a diffraction grating configured to receive an incident light beam and to generate a spectrally separated light beam therefrom; a collimator lens configured to receive the spectrally separated light beam and to generate a collimated light beam therefrom; a two-dimensional spatial light modulator (SLM) encoded with a two-dimensional map of phase values including a phase function and an amplitude modulation function, the two-dimensional SLM configured to receive the collimated light beam and to generate an amplitude-and-phase-modulated light beam therefrom; and a controller, wherein the controller is configured to control a calibration of the pulse shaper based on a look-up table which maps input pixel values of the SLM to output phase values over a wavelength range including a bandwidth of the collimated light beam.

### BRIEF DESCRIPTION OF THE DRAWINGS

Features, objects, and advantages of the present technology will become more readily apparent when consideration is given to the detailed description below. Such detailed description makes reference to the following drawings, wherein:

FIG. 1 illustrates examples of conceptual and optical designs according to various aspects of the present disclosure.

FIG. 2 illustrates example amplitude modulation results according to various aspects of the present disclosure.

FIG. 3 illustrates example spatial profile characteristics according to various aspects of the present disclosure.

FIG. 4 illustrates examples of calibration parameters and results according to various aspects of the present disclosure.

FIG. 5 illustrates an example of TSS-HS-CARS modification, calibration, data acquisition, and processing according to various aspects of the present disclosure.

FIG. 6 illustrates an example characterization of chemical compounds according to various aspects of the present disclosure.

FIG. 7 illustrates examples of shaped-Stokes HS-CARS of ex vivo mouse tissue according to various aspects of the present disclosure.

FIG. 8 illustrates example intensity and lifetime measurements according to various aspects of the present disclosure.

FIG. 9 illustrates example pump shaping TSS-HS-CARS results according to various aspects of the present disclosure.

FIG. 10 illustrates example synchronization results according to various aspects of the present disclosure.

FIG. 11 illustrates an example of spectrally tailored CARS according to various aspects of the present disclosure.

FIG. 12 illustrates an example flowchart for generating SLM patterns according to various aspects of the present disclosure.

FIG. 13 illustrates an example differentiation of two beads using two tailored spectral masks according to various aspects of the present disclosure.

FIG. 14 illustrates example imaging characteristics according to various aspects of the present disclosure.

FIG. 15 shows example images according to various aspects of the present disclosure.

FIG. 16 illustrates example microscopy implementations according to various aspects of the present disclosure.

FIG. 17 illustrates example imaging results according to various aspects of the present disclosure.

FIG. 18 shows example images according to various aspects of the present disclosure.

FIG. 19 illustrates example imaging results according to various aspects of the present disclosure.

FIG. 20 illustrates an example microscopy system according to various aspects of the present disclosure.

### DETAILED DESCRIPTION

The present technology will now be described more fully with reference to the accompanying drawings, in which some, but not all, embodiments are shown. Indeed, the technology may be embodied in many different forms and should not be construed as limited to the embodiments set forth herein; rather, these embodiments are provided so that this disclosure will satisfy applicable legal requirements.

Likewise, many modifications and other embodiments of the technology described herein will come to mind to one of skill in the art to which the invention pertains having the benefit of the teachings presented in the following descriptions and the associated drawings. Therefore, it is to be understood that the disclosure is not to be limited to the specific embodiments disclosed and that modifications and other embodiments are intended to be included within the scope of the disclosure. Although specific terms are employed herein, they are used in a generic and descriptive sense only and not for purposes of limitation. Unless defined otherwise, all technical and scientific terms used herein have the same meaning as commonly understood by one of skill in the art to which the technology pertains.

The present disclosure provides for systems, devices, and methods which may be used in microscopy systems. For example, the present disclosure relates to improvements in a pulse shaper design useful for hyperspectral microscopy techniques. Without wishing to be bound to any particular theory of operation, the pulse shaper designs and calibrations set forth herein may perform high-precision amplitude and phase shaping independently and accurately. For example, the pulse shapers set forth herein may provide for spectral filtering (e.g., selecting frequency components by suppressing unwanted frequencies), beam shaping, and the like that are resilient to higher-order dispersion effects.

While the following description, is presented primarily in the context of coherent anti-Stokes Raman scattering (CARS) microscopy, the optical systems and methods set forth herein may also be applied for any multi-beam hyperspectral imaging modality. For example, the systems and methods set forth herein may be applied to stimulated Raman scattering (SRS) microscopy, hyperspectral sum-frequency generation (SFG) microscopy, and other such forms of microscopy.

In CARS, a pump beam (ωₚ) and a Stokes beam (ωₛ) with a frequency difference equal to the Raman vibrational frequency of a molecule Ω_{R}=ωₚ−ωₛ, generate an anti-Stokes signal at a new frequency ωₐₛ=2ωₚ−ωₛ. Development of computational methods, such as the Kramers-Kronig (KK) phase retrieval and detrending, have enabled the removal of the unwanted non-resonant background (NRB) to enable CARS as a ubiquitous tool for high-resolution spectral characterization. Single-frequency CARS microscopy, where the pump and Stokes beam frequencies are tuned to probe a single vibrational frequency, has limited specificity, and provides minimal chemical information. Hyperspectral CARS (HS-CARS) microscopy is used for comprehensive chemical characterization of samples and visualization of the chemical information at a microscale. The spectral and temporal characteristics of the pump and Stokes beams dictate the speed, tunability, and efficiency of CARS generation. Precise control of the spectral and temporal profiles of the beams can yield CARS techniques for new applications.

Comparative examples of HS-CARS can be broadly categorized as being multiplexing-based or sequential scanning-based techniques. In multiplexing-based HS-CARS, a broadband Stokes beam is compressed in time and interacts with a narrowband pump. The CARS spectrum is recorded by a spectrometer at each pixel. Although each spectrum at each pixel can be acquired within a few milliseconds, the frame duration scales up significantly with the number of pixels for microscopy applications. Two comparative methods of sequential scanning-based HS-CARS use narrowband beams for both pump and Stokes. The first method is through direct laser wavelength tuning, achieved using tunable lasers or optical parametric oscillators (OPO). HS-CARS using either technology requires quickly tuning the temporal delay between the pump and Stokes beams for each vibrational frequency by either mechanical or electronic means. These, often customized, lasers and OPOs are not readily accessible to researchers, and are difficult to be adapted into commercial or multimodal imaging platforms. Another comparative method for sequential scanning for HS-CARS is spectral focusing, where the pulses in both the pump and Stokes beams are chirped and stretched to picosecond pulse widths. Different frequencies of Raman vibrations can be probed by tuning the temporal overlap of the two beams. There are several limitations of this comparative spectral focusing method. First, temporal delay tuning usually involves mechanical movements from piezoelectric-driven stages or scanning mirrors. These electromechanical elements can be unstable due to hysteresis and cause misalignment of the two beams between or within imaging sessions. Rigorous and regular calibration is needed to map the optical path length difference to the vibrational frequency difference to avoid distortions to the recorded CARS spectra. Second, since the two beams are only partially overlapped in time for any single vibrational frequency, the excitation power is not efficiently used to generate the CARS signals, which can exacerbate the photodamage to biological samples. Third, since the overlap between the pump and Stokes is not uniform, the detected spectra are bounded by an envelope function that further constricts the range.

In all these comparative methods, precise control of the spectral and temporal profiles is essential to obtain efficient and accurate measurements with good spectral resolution. Generally, the improved spectral resolution in scanning-based HS-CARS is achieved when the dispersion and the temporal and spectral bandwidths of the pump and the Stokes beam are linear and identical. The beam dispersion may be controlled using elements such as fiber brag gratings, prism pairs, chirped mirrors, or glass rods. These elements are limited to compensating only second-order dispersion and have limited tunability in comparative implementations. Fourier transform pulse shaping (FTPS) may be used as a technique for manipulating the temporal and spectral properties of laser pulses, for example with a diffraction grating and a spatial light modulator (SLM) in a 4-f configuration. In comparative examples, SLMs in the pulse shaper only have a linear array of pixels made of liquid crystals (LCs) for one-dimensional control of the spectral profile. Two-dimensional (2D) SLMs exist in the market, have higher pixel density compared to their 1D counterparts, and are generally more affordable than a commercial FTPS. Both 1D and 2D SLMs can modulate the spectral phase of input pulses. However, 1D SLMs modulate the amplitude of each spectral bin using polarization modulation with respect to the SLM LC axis which also affects the efficiency of phase modulation. Independent amplitude control can be achieved with two serial layers of 1D SLMs at a cost of increased power loss and added dispersion artifacts. In contrast, independent amplitude modulation by 2D SLMs achieves higher power efficiency using diffraction-based methods. Amplitude modulation using 2D SLMs have applications in various applications, such as optical metrology, quantum optics and optical processing, and has been made commercially available. Despite applications in other fields, 2D SLMs have not been used to generate a “swept source” for high-speed HS-CARS microscopy.

The present disclosure sets forth a method to perform HS-CARS, called herein “Temporally and Spectrally Shaped HS-CARS” (TSS HS-CARS), with quick, versatile, and independent spectral and temporal tunability using a Fourier-transform pulse shaper with a 2D-SLM that overcomes the limitations of comparative scanning-based HS-CARS techniques. In TSS-HS-CARS, a spectrally broadband pulse (˜2000 cm⁻¹) is obtained at either the pump or the Stokes bands using supercontinuum generation, whose amplitude and phase are then tuned independently for every spectral sub-band (10-20 cm⁻¹) using the 2D-SLM-based FTPS, based on the application and upon interaction with the other beam. This method does not involve any mechanically moving elements, minimizes photodamage by modulating and utilizing the incident pulse energy efficiently, and achieves stable operation at high speed. It also affords wide tunability to various spectral resolutions and bands, provides flexible acquisition schemes, and can be readily integrated into a multimodal imaging system that incorporates a single commercially available laser source.

### Experimental Demonstration

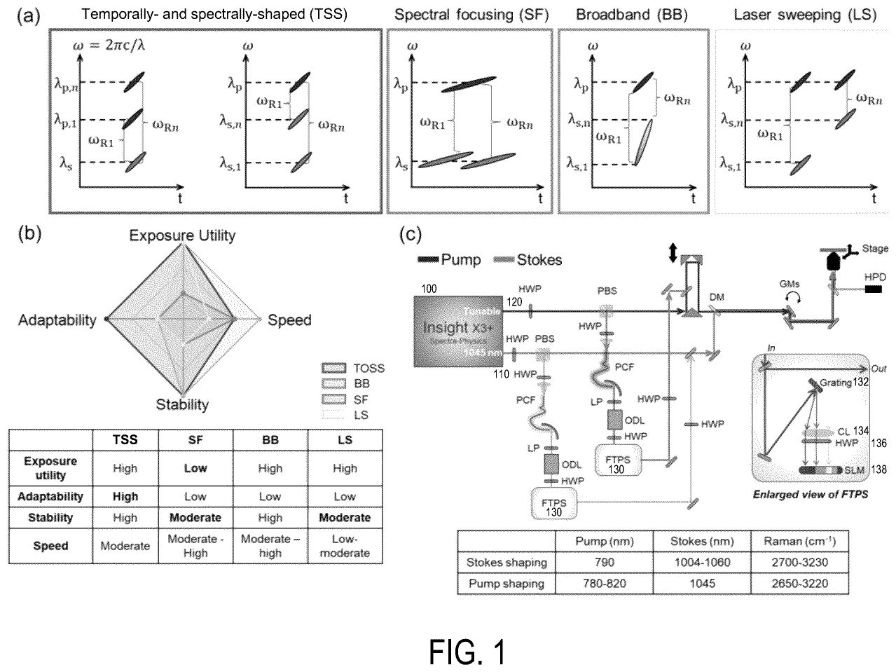

FIG. 1 illustrates examples of conceptual and optical designs of TSS-HS-CARS. Diagram set (a) shows time-frequency distribution diagrams of TSS, SF, BB, and LS HS-CARS show differences in frequency bandwidth, pulse width, and temporal overlap. Graph (b) shows a qualitative comparison of TSS, SF, BB, and LS HS-CARS in terms of exposure utility, speed, stability, and adaptability. Diagram (c) shows an optical setup diagram of TSS HS-CARS that can perform either shaped-pump or shaped-Stokes operation. The pump (shaped and original) beam is darker, and the Stokes (shaped and original) beam is lighter. The two pulse shapers have the same optical design with different choices of components. The table summarizes the pump and Stokes wavelengths and the range of Raman vibrational frequencies probed by the shaped-pump and shaped-Stokes configurations. In FIG. 1, the following acronyms are used: HWP, half-wave-plate; PBS, polarization-sensitive beam splitter; PCF, photonic crystal fiber; LP, linear polarizer; QWP, quarter waveplate; GM, galvanometer mirror; DM, dichroic mirror; FTPS, Fourier transform pulse shaper; HPD, hybrid photodetector; CL, cylindrical lens; SLM, spatial-light modulator; ODL, optical delay line.

Exposure utility describes the percentage of incident power (both pump and Stokes) that contributes to CARS signal generation. The discussion of speed here pertains specifically to the acquisition rate of a data cube containing the spectrum for each pixel in an image. The stability metric refers to the ability to get repeatable HS measurements within and across imaging sessions. Adaptability describes the flexibility in acquisition methods, ranges of Raman frequencies, and the ability to be integrated into a multimodal platform. In TSS-HS-CARS, either the pump beam or the Stokes beam can be spectrally shaped to match the pulse width and frequency bandwidth of the other beam. High-fidelity phase modulation is used to minimize the dispersion mismatch of the two-color beams, while high-efficiency amplitude modulation is used to perform sub-nanometer wavelength selection and tuning. Pulse shaping ensures complete or nearly complete temporal overlap of the two beams, which indicates high exposure utilization, and stable operation during fast tuning. Unlike SF, where both the pump and Stokes beams are narrowband and chirped, TSS-HS-CARS can operate for various pulse-width regimes (picosecond to femtosecond). Additionally, the time-frequency distribution of the two beams in SF and LS HS-CARS are empirically assumed to be the same (i.e., identical ellipses in the diagram). But this is practically challenging without the pulse shaper due to higher-order dispersion. Additionally, the partial temporal overlap in SF-HS-CARS also means poor utilization of the optical energy exposed to the samples. Two possible configurations of TSS-HS-CARS with pulse shapers in either the pump or Stokes beams (diagram (c)) for characterizing different chemical compounds and lipid-protein contents in biological samples are described in more detail below. A series of steps to design, calibrate, and operate a 2D FTPS device for tunable HS-CARS microscopy are also described in more detail below.

Diagram (c) shows the system setup and the detailed design of the pulse shaper. Generally, diagram (c) of FIG. 1 shows a microscopy system comprising a laser 100 configured to output a first beam (e.g., via a tunable output) to a first optical system 110 and a second beam (e.g., via a fixed output) to a second optical system 120. The first optical system 110 comprises a first pulse shaper 120 configured to shape a first component of the first beam in at least one of a spectral aspect or a temporal aspect. As illustrated, the first pulse shaper 130 includes a diffraction grating 132, a collimating lens 134, an achromatic half-wave plate 136, and a 2D SLM 138. Additionally, in the illustrated example, the second optical system 120 comprises a second pulse shaper 120 configured to shape a second component of the second beam in at least one of a spectral aspect or a temporal aspect. In this example, the second pulse shaper 130 has the same structure as the first pulse shaper 130.

While the two FTPSs were incorporated into the setup for the pump and Stokes, they were not operated simultaneously. The pump beam is sourced from the tunable output of the laser (e.g., InsightX3+, 80 MHz, Spectra-Physics) and the Stokes beam is sourced from the fixed output of the laser (centered at 1045 nm). The base design combines the pump and Stokes beam with a dichroic mirror (DM) (e.g., FF880-SDi01, Semrock) with independent optical delay lines for the pump and the Stokes beams. Both have independent polarization control using a pair of half-wave plates to match their optical axes at the sample plane. The combined beams were scanned using a pair of galvanometer mirrors (GMs) (e.g., 6220H, Cambridge Technology), and were focused onto the sample by the objective (e.g., XLPLN25XWMP2, Olympus Corporation). The CARS signals were detected by a hybrid photodetector (HPD) (e.g., R10467U-40, Hamamatsu) after collection in the epi direction and after passing through spectral filters.

In the Stokes pulse-shaping scheme, 1.3 W of 1045 nm output was coupled into a photonic-crystal fiber (PCF) (e.g., LMA-PM-10, NKT Photonics) to generate a broadband continuum of 200 nm bandwidth (base-to-base). The output of the PCF was shaped by a custom pulse-shaper which can perform high-precision amplitude and phase shaping independently, where the pulse-shaper includes a diffraction grating (e.g., 263232-8112-024, 900 lines/mm, blazed at 1000 nm, Zeiss) that separates the spectrum spatially, an achromatic half-wave plate (e.g., AHWP05M-980, Thorlabs) to modify the input polarization for increased SLM efficiency, a 75-mm cylindrical lens (e.g., ACL-254-75-B, Thorlabs) to collimate each spectral component, and a 2D SLM (e.g., SLM 200, 1920×1200 pixels, Santec). This particular combination of components was chosen such that the 200-nm bandwidth of the continuum spans the longer edge of the SLM, corresponding to about 0.1 nm (˜1 cm⁻¹) per pixel. A half-wave plate placed at the input of the pulse shaper modifies the polarization of the beam for increased efficiency of diffraction from the grating. The shaped Stokes beam was then combined and coupled back into the original Stokes beam path (from the output of the laser). An optical delay line (ODL) was inserted between the PCF and the FTPS to delay the shaped Stokes beam by 1 laser pulse period (12.5 ns for 80 MHz) compared to the pump. In the Stokes-shaping scheme, the pump power at the sample arm was around 15 mW and each spectral window of Stokes was around 1˜2 mW. The shaped-Stokes method may be preferable in some implementations because the CARS signal strength is proportional to the square of the pump power.

The pump-shaping scheme has a similar design to the Stokes-shaping scheme, where the pump frequencies were generated by another PCF (e.g., LMA-PM-5, NKT Photonics) pumped at 0.8 W at 800 nm and shaped using a custom pulse shaper with a similar design using a 600 lines/mm grating, blazed at 775 nm (e.g., Zeiss), an achromatic HWP, a 50-mm cylindrical lens (e.g., ACL-254-50-B, Thorlabs), and a 2D SLM (e.g., Meadowlark, 512×512 pixels). This particular combination of components was chosen such that the 150-nm base-to-base bandwidth of the continuum spans one edge of the SLM, corresponding to an average of 0.3 nm (˜4 cm⁻¹) per pixel. The shaped pump beam is temporally delayed by one laser period relative to the 1045-nm output of the laser. The description of the optical design and instrumentation in the shaped-pump and shaped-Stokes schemes is included in Table 1, below. In the particular examples described here, the grating and the cylindrical lens were chosen based on the bandwidth of the input beam and the width of the SLM active area.

TABLE 1
Specification comparison between two SLMs
used in pump-shaping and Stokes-shaping

| | Pump shaping | Stokes shaping |
|---|---|---|
| SLM pixels | 512 × 512 | 1920 × 1200 |
| Bit depth | 16 | 10 |
| Pixel pitch (μm) | 15 × 15 | 7.8 × 7.8 |
| Active area (mm) | 7.68 × 7.68 | 15.36 × 9.6 |
| Fill factor | 90% | 95% |
| Control | PCIe | DVI/USB |
| Price | N/A, discontinued | ~$10k |
| Manufacturer, age | Meadowlark Optics, 5+ years | Santec, 1 year |

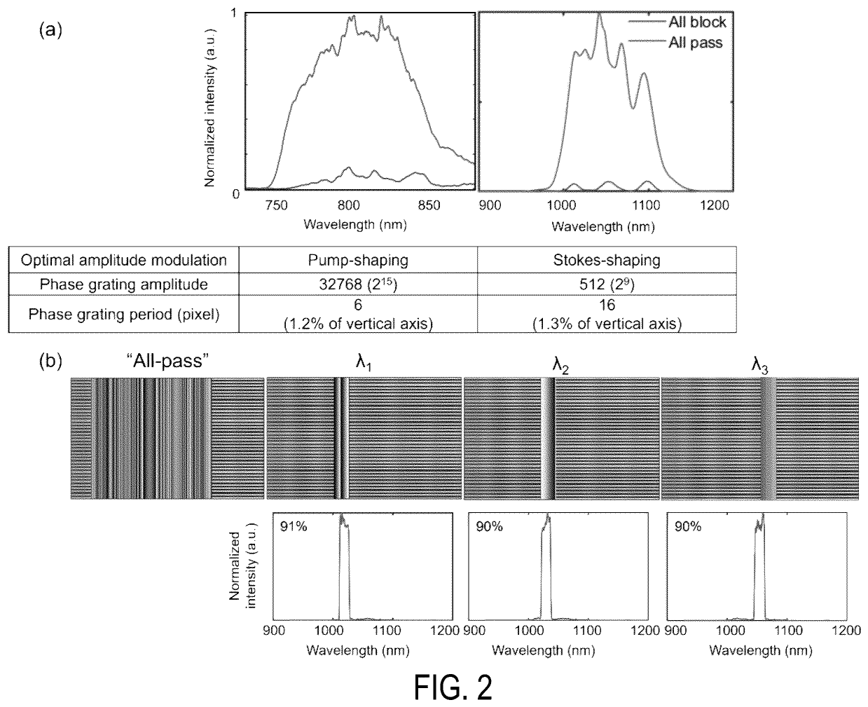

To use a pulse shaper for HS-CARS, there are four calibration steps: 1) implementation of spectral filtering using the FTPS, 2) improving and stabilizing the beam profile along the beam path after the FTPS for different spectral and temporal profiles, 3) calibrating a look-up table (LUT) to accommodate the spectrally-dependent voltage-to-phase modulation of the liquid crystals, and 4) matching the spectral and temporal characteristics of the pump and Stokes beams for optical HS-CARS performance. The first step is to achieve great spectral filtering performance using the 2D SLM. The principle of amplitude modulation using a 2D SLM utilizes constructive and destructive interference of each spectral component of the beam by imparting periodic patterns in a direction orthogonal to the axis of spectral spreading. In one example setup, the different frequencies were horizontally displaced on the SLM along its longer axis. By vertically encoding a phase grating on each column (e.g., via an amplitude modulation function), the amplitude of each frequency component can be independently modulated in either a zero- or first-order diffracted beam. The phase grating is defined as a periodic rectangular function with an amplitude (A) and width (P/2). For simplicity, a zero-order approach may be adopted. The incident beam and the diffracted output were slightly vertically displaced (<1 rad). In this approach, the output intensity of a certain frequency component (I₀(ω)) is related to the amplitude (A(ω)) of the phase grating by the relation: I₀(ω)˜cos²(A(ω)/2). It is clear that an amplitude of π results in the maximum modulation in suppressing the intensity. The overall efficiency also depends on the period of the phase grating, and it varies with different SLMs. By modifying the efficiency, in the Stokes FTPS, the SLM can achieve over 90% modulation depth over the entire 200-nm bandwidth. Examples of amplitude modulation results can be found in FIG. 2. After amplitude modulation is modified, the pulse shaper is capable of selecting frequency components by suppressing the unwanted frequencies. This was used to accurately determine the wavelength-to-pixel relationship. All spectral measurements during the calibration were performed using a USB spectrometer (e.g., USB4000, Ocean Optics) or an optical spectrum analyzer (OSA, e.g. OSA 202C, Thorlabs).

In FIG. 2, graph set (a), shows amplitude modulation results for pump shaping and Stokes shaping SLMs. The parameters used for the phase grating along the vertical axis are listed in the table below the plots. Both pump shaping and Stokes shaping SLMs were able to achieve 90% modulation. FIG. 2, image set (b), shows examples of the phase masks used on the Stokes shaping SLM. The “All-pass” mask had around quadratic compression over the selected spectral range, which is shown as aperiodic vertical strips due to phase wrapping, while the unwanted range was suppressed by the vertical phase grating, which is shown as periodic horizontal strips. The λ₁, λ₂, λ₃ masks demonstrate narrow-band wavelength selection. Spectrometer data (averaged over 10 acquisitions) are shown for the three spectral windows.

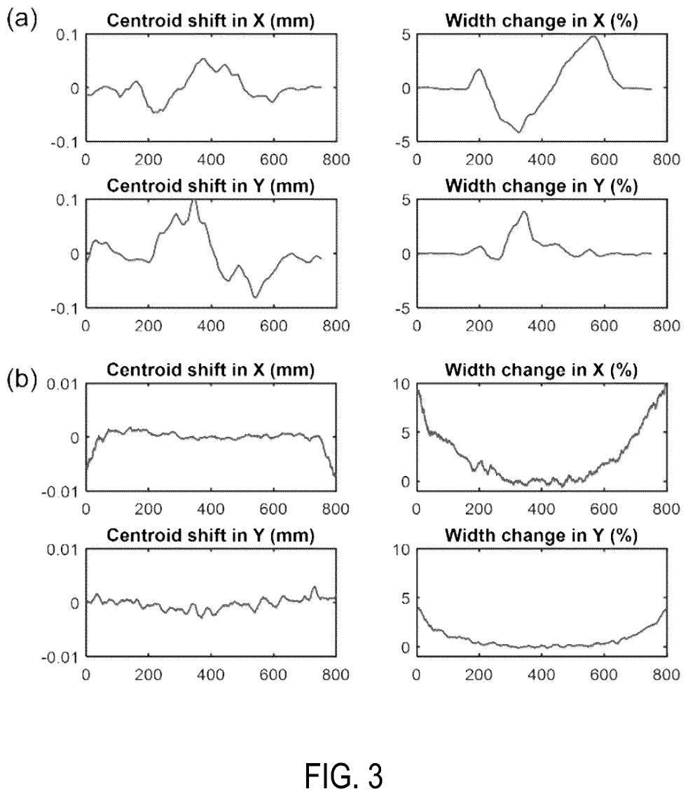

The next step is to refine the beam profile at the output such that the beam maintains a radially symmetric Gaussian-like shape and holds a stable centroid location during the wavelength sweeping, which is beneficial for HS-CARS since the spatial overlap of the pump and Stokes directly affects the signal strength. This is mainly achieved by fine-tuning the optical alignment of the grating, rotation, position, and axis of the cylindrical lens, and the tip, tilt, and position of the SLM, and by monitoring the beam profile using a camera (e.g., MQ013CG-ON-S7, XIMEA) in the far field after different arbitrary distances of propagation. The stability of the alignment was tested during wavelength sweeping and amplitude modulation by monitoring the beam profile and location before each experiment session. FIG. 3 shows an example of spatial profile stability evaluation according to changes in the centroid location and width. In particular, for graph set (a) of FIG. 3, the shaped pump beam profile was captured by the camera at the far field while sweeping wavelengths over 750 nm to 850 nm using the SLM. The output beam center shifted less than 0.1 mm and the width changed by less than 5% in both x and y directions. In graph set (b) of FIG. 3, the amplitude of the shaped Stokes beam of 200 nm bandwidth was modulated from 0 to 100% to 0. The beam center shifted less than 0.01 mm and the width changed less than 10% in both directions. The centroid location and the full-width half maximum (FWHM) variations were quantified using Gaussian fitting of the beam profile in two dimensions. The FWHM of the shaped pump beam and the shaped Stokes beam were estimated to be 1.3 mm and 0.45 mm, respectively. The SLM in the Stokes FTPS also has a wavefront correction feature to help reduce the wavefront distortion at the far field. The beam size and shape were also adjusted using a 4f telescope at the output of the pulse shaper to ensure that the shaped beam had a slightly smaller beam diameter than the direct output of the laser, and consequently, a lower numerical aperture to increase the tolerance of alignment in scattering samples by having a slightly larger depth of focus.

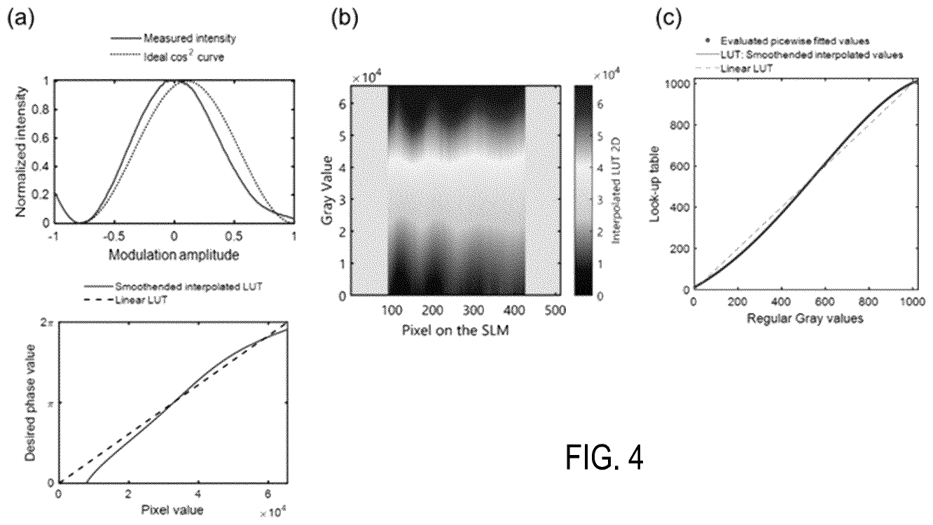

After the alignment was modified, a look-up table (LUT) for the SLM pixel intensity value and the desired phase value was then calibrated. While some commercially available SLMs have built-in LUTs at a few selected wavelengths, the phase response of the liquid crystal is subject to various external factors such as age, temperature, and humidity. The phase response is also optical-frequency-dependent and spatially nonuniform. Therefore, LUT calibration may be performed on SLMs to ensure an accurate phase response across the full bandwidth. The amplitude modulation principle described above was used, and modulation efficiency was measured by differing the value of A (in pixel intensity) about a fixed center set to 2^{b-1}, where b is the bit depth of the SLM. For example, for a 10-bit SLM, a linear LUT should map pixel intensity values of 0-1024 to phase values of 0-2π. Theoretically, if the phase grating amplitude, A, were varied from 0 to 1024, the intensity response would follow a cos² ϕ curve where ϕ ranges from 0 to π. However, the response may not be linear and may vary with frequency and spatial location on the SLM. FIG. 4 shows an example of the mismatched measured modulation effect and the theoretical cos² ϕ response. By inverting the modulated intensity using an inverse cosine and interpolating it for every unique pixel intensity values in MATLAB 2022 (fitted to “spline”), a LUT can be obtained for mapping the regular grey values (pixel values) to the actual/desired phase values for every wavelength. FIG. 4 also shows examples of the fitting results on the pump FTPS SLM and the Stokes FTPS SLM, compared to a linear fit. In FIG. 4, graph sets (a, b) show look-up table (LUT) calibration for pump shaping SLM; in particular, graph (a) shows single frequency and space invariant LUT calibration steps, i.e., intermediate steps, showing the deviation of measured amplitude modulation results from the theoretical results, and graph (b) shows 2D LUT calibration results for pump shaping SLM. Graph (c) shows an intermediate step of LUT calibration for Stokes shaping at one single frequency band.

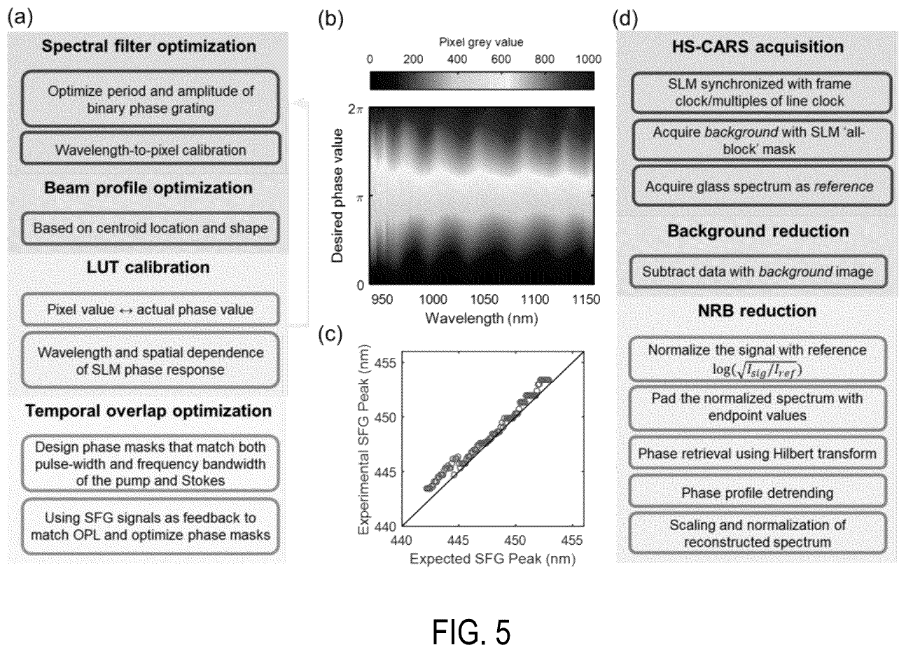

One way to account for spatial and frequency dependence is to do the LUT calibration on each pixel for several wavelength sub-bands within the spectral range of operation. However, in the example discussed here, the frequency is the same for each column on the SLM, so the LUT calibration was performed on each column using a broadband beam and capturing the intensity trends using a USB spectrometer (e.g., USB4000, Ocean Optics). FIG. 5 illustrates an example of TSS-HS-CARS modification, calibration, data acquisition, and processing. Inset (a) shows calibration steps including designing spectral filtering using the amplitude modulation capability of a 2D SLM, wavelength-to-pixel calibration, beam profile refinement, LUT calibration and validation, and pump-Stokes temporal overlap validation using SFG response. Image (b) shows a LUT for the Stokes PS SLM. Graph (c) shows experimental SFG peak locations in the shaped-Stokes scheme. Inset (d) shows steps for data acquisition and postprocessing including frame/sub-frame synchronization, background reduction, and non-resonant background (NRB) reduction based on the Kramers-Kronig (KK) relation. The LUT calibration result for the Stokes-shaping SLM is shown in graph (b) of FIG. 5.

The above SLM calibration operation may include intermediate calibration steps for the LUT for pump shaping SLM. Output intensity was measured at varying modulation amplitude/depth. The output intensity should follow a squared-cosine relationship as indicated by the dashed curve in the plot of graph set (a) of FIG. 4. This is based on the diffraction-based amplitude modulation method described above. However, the measured intensity profile deviated from the theoretical curve which indicated the need for LUT recalibration. The actual/effective modulation amplitude was then calculated and the deviation from a linear fit can be observed in the bottom plot of graph set (a). Considering the spatial and the frequency dependence of the phase response of SLM, the LUT calibration was performed in 2D and the result for the pump shaping SLM is shown in graph (b) of FIG. 4. The LUT calibration for Stokes shaping LUT showed that the effective modulation depth was close to the expected value as indicated by the fitted curve close to a linear line in graph (c) of FIG. 4.

Next, to achieve the temporal overlap of the pump and the Stokes, as shown in diagram set (a) of FIG. 1, the two beams should have substantially the same pulse width and substantially the same frequency bandwidth. Moreover, the two beams should also have substantially the same dispersion profile for maximum spectral resolution. In the Stokes-shaping scheme, the 1/e² bandwidth of the pump centered at 790 nm was measured to be 10 nm (160 cm 1), which corresponds to an 18 nm bandwidth for the Stokes beam centered at 1045 nm. Initially, a quadratic phase function ϕ(ω)=A₂(ω−ω₀(ω))² with the A₂ being −2000 fs² and a center frequency ω₀ at 1045 nm was applied along the frequency axis (i.e., the horizontal axis of the SLM) to achieve the same pulse width of the pump beam, measured to be 850 fs FWHM at the sample plane using an autocorrelator (e.g., Carpe, APE). To temporally overlap the pulses of the pump and shaped Stokes, the sum-frequency generation (SFG) response from a beta barium borate (BBO) crystal was recorded using a spectrometer. SFG was maximized first at the selected band (18 nm 1/e² bandwidth) centered at 1045 nm. The goal was to achieve a linear spectral response of the SFG spectrum and a constant SFG amplitude while sweeping Stokes frequencies. It was found that fine adjustment of the ω₀ for each selected narrow band resulted in a more uniform SFG amplitude and more linearly spaced peak SFG frequency. This is equivalent to adding a frequency-dependent linear term to the phase modulation function, which corresponds to a frequency-dependent temporal delay. For each w in the bandwidth, the SFG response was acquired for a series of ω₀ over a large range. The ω₀(ω) frequencies were chosen such that the overlap between the expected SFG response, which was modeled as a Gaussian spectrum with a linewidth of around 80 cm⁻¹ calculated from the measured line widths of the pump and Stokes beams, and the measured SFG response, was maximized. Graph (c) of FIG. 5 shows an example of experimental SFG peak locations during the frequency sweep as compared to calculated peak locations, which were observed to follow an overall linear trend. In the time domain, this is equivalent to tuning the optical path length delay for each optical band; however, TSS-HS-CARS achieves this without any moving parts.

Prior to collecting data on each day of operation, the output of the Stokes PCF was first set to 650 mW and fiber coupling efficiency was maximized using fine alignment of the fiber stage. The optical delay unit in the pump was then adjusted such that the SFG spectrum from the BBO crystal at the sample plane was maximized and was centered at 447 nm when a mask passing the center band at 1030±9 nm was applied to the Stokes via SLM (when the pump beam was centered at 790 nm). The procedures described here for the shaped-Stokes TSS-HS-CARS were repeated for the shaped-pump TSS-HS-CARS with the appropriate parameters for each instrument.

A series of patterns were generated for sweeping the Stokes beam wavelength across the spectral range, where the passband included a quadratic function along the horizontal direction with the previously calibrated values of A₂ and ω₀(ω) and the stop band included a phase grating with an amplitude of π centered at 2^{b-1}. All the patterns were initially computed as phase functions, digitally wrapped and confined to a range of −π to π, and then converted to pixel intensity values using the calibrated LUT for each spectral component. An example of a pattern is shown in FIG. 4, graph (b). Image acquisition was performed using custom LabVIEW software (National Instruments) and a data acquisition and timing module (e.g., PCIe 6356, NI). The SLM can be synchronized with an external trigger for sweeping different patterns, advertised at up to 60 Hz. However, practically, the observed slew rate for the full range was closer to 100 ms. The digital triggers for every frame or a set of a few lines were exported from the timing module to the trigger port of the SLM. The predominant acquisition method used in this example was x-y-f, where the SLM was synchronized to the frame clock of image acquisition which was typically ˜1 Hz. The trigger was advanced from the actual start of the frame by ˜100 ms to account for the slew in changing the pattern. Note that this slew rate is different from the response time of the LCs.

In the Stokes-shaping scheme, the series of patterns not only included the phase masks for sweeping the Stokes wavelengths from 1000 nm to 1060 nm, but also included a phase mask passing the entire 1000-1060 nm band compressed to around 200 fs (referred to as “all-pass mask”), and one suppressing the entire band (referred to as “all-block mask”). The latter was used to remove background signals within the emission band generated by the pump alone. In this example, it was assumed that most of the signals detected in the same spectral window were either autofluorescence signals excited by the pump beam or the pump beam leaking into the detector despite the high-efficiency cutoff filters. The pump beam was set at 790 nm and around 10-20 mW at the sample plane, whereas each sweep of the Stokes beam had 1-2 mW at the sample plane. The image generated by the all-pass mask was used to visualize the spectrally-agnostic structures of the sample. The spectra from a clean block of glass collected using the same phase masks under the same imaging conditions were used as the reference for NRB reduction in the processing.

After the acquisition, the background image acquired using the all-block mask was first subtracted from all the HS-CARS images. For the spectroscopic characterization of pure solutions, since the field of view (FOV) is mostly uniform, the mean intensity from the image at each frequency was used to construct the raw signal spectrum. For NRB reduction, the phase-corrected KK-relation phase retrieval algorithm was adopted. The raw signal spectrum (I_{sig}) was first normalized by the glass spectrum (I_{ref}): A_{sig}(ω)=log (\sqrt{I_{sig}(ω)/I_{ref}(ω)}). To reduce the edge artifacts from the Hilbert transform, the spectrum was padded with end-point values to extend the spectrum by 10 times in length. After Hilbert transform of the normalized signal, A_{sig}(ω), the imaginary part was used as the reconstructed phase of the CARS signals. A first-order detrending was then performed on the retrieved phase to correct the phase error, with the assumption that the phase has a zero baseline. The baseline-corrected phase was then used to reconstruct the CARS spectrum with intensity rescaling by \sqrt{I_{sig} (ω)/I_{ref}(ω)}. A first-order amplitude baseline detrending was optionally performed. All the processing was performed post-acquisition using MATLAB R2022b and the standard detrending function.

Approximately 1 mL of pure solutions of dimethyl sulfoxide (DMSO), methanol, glycerol, ethanol, and water were separately placed in clean cover glass-bottomed Petri dishes (e.g., P35G-O-14-C, MatTek) prior to imaging. A polydimethylsiloxane (PDMS) sample was prepared by mixing PDMS with room-temperature vulcanizing agents (RTVA for curing and RTV-B for crosslinking) in the ratio of 100:10:1 and set for several hours to form a stable gel at room temperature. The glass background was collected from a glass microscope slide (e.g., Premium microscope slide superfrost, 12-544-7, Fisher Scientific). The spectra for all solutions, gels, and glass were collected in the epi direction from a depth of 10-20 μm below the surface. All spectra were acquired as 256×256×103-pixel data cubes with 12.5 us exposure time per pixel, where the first two dimensions indicate the transverse image size, and the last dimension indicates the number of spectral components collected. The 103 patterns included 101 patterns of the Stokes wavelength swept at an interval of 5.4 cm⁻¹ between 2690 cm⁻¹ and 3228 cm⁻¹, the all-pass phase mask, and the all-block phase mask.

A mouse was euthanized by CO₂ asphyxiation and tissues were surgically resected and placed in an imaging dish with a clear cover-glass bottom containing approximately 100 μL of freshly prepared phosphate-buffered saline. The dishes were placed on ice and the tissues were imaged with a few hours of extraction. All animal procedures were conducted in accordance with a protocol approved by the Illinois Institutional Animal Care and Use Committee at the University of Illinois at Urbana-Champaign. The images were either collected as 256×256×103-pixel data cubes in the same configuration as the data for the pure compounds, or as 6×3 tiles of 256×256×33-pixel data cubes each (10 cm⁻¹ spacing between 2750 cm⁻¹ and 3050 cm⁻¹, the all-pass phase mask, and the all-block phase mask). To generate lipid-to-protein maps, normalized gaussian windows centered at 2850 cm⁻¹ (lipid) and 2950 cm⁻¹ (protein) with a bandwidth of 40 cm⁻¹ (the system's spectral resolution) were used to filter out the CARS signal contributions from lipids and proteins.

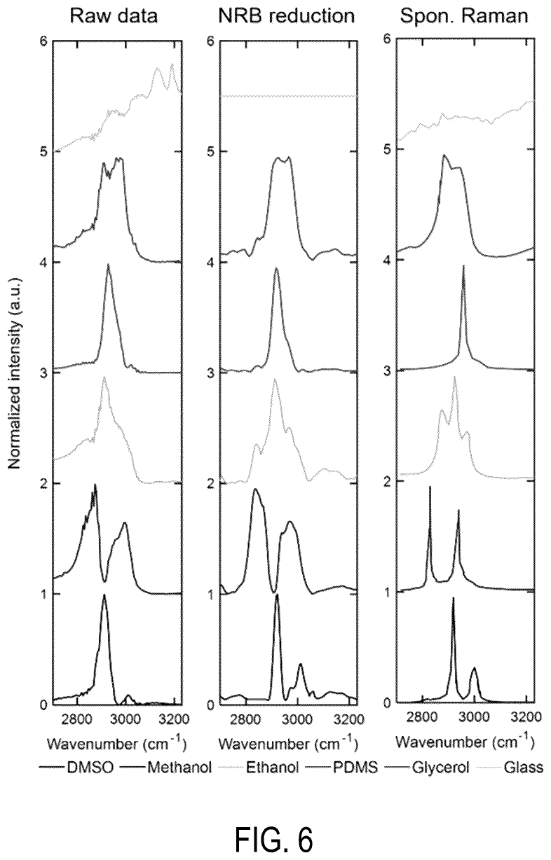

First, the Stokes-shaping HS-CARS can be used to characterize different chemical compounds, including dimethyl sulfoxide (DMSO), methanol, ethanol, cured polydimethylsiloxane (PDMS), and glycerol, where the spectrum from the glass was used as the reference for NRB reduction. The Stokes wavelength was swept from 1004 nm to 1060 nm with an interval of 0.5 nm, which resulted in Raman spectra ranging from 2690 cm⁻¹ to 3228 cm⁻¹. The results were compared to the spontaneous Raman spectra as shown in FIG. 6, which shows an an example characterization of chemical compounds by shaped-Stokes HS-CARS, including dimethylsulfoxide (DMSO), methanol, ethanol, polydimethylsiloxane (PDMS), glycerol, and glass. The left column contains spectra obtained from the mean intensity of each frame acquired at each shaped-Stokes wavelength before NRB reduction, referred to as the “raw data.” The middle column contains the reconstructed spectra after KK-relation-based NRB reduction. The right column contains the spontaneous (Spon.) Raman spectra of the compounds collected from a spontaneous Raman confocal microscope. All spectra were normalized for visualization. Even before NRB reduction, the CARS spectra were visually similar to the spontaneous Raman spectra despite some differences in the shape, peak location, and bandwidth of individual peaks. These trends were more like spontaneous Raman scattering spectra after NRB removal. For instance, the two peaks of different intensities of DMSO, the two peaks of similar intensities in methanol, the three peaks of different intensities of ethanol, the single narrow peak of PDMS, the single broad peak of glycerol, and the lack of any distinct vibrational peaks of glass were all recovered accurately with the example technique after NRB removal.

For DMSO (FIG. 6, bottom trace), the strongest peak in the spectrum before correction was located at 2902 cm⁻¹ with a FWHM of 40 cm⁻¹. The theoretical spectral resolution was calculated to be around 34 cm⁻¹ with the Stokes-shaping scheme, assuming pure second-order dispersion. The experimental data showed good accordance with the theoretical calculation. While not wishing to be bound by any particular theory of operation, the peak shift towards lower frequency may be caused by the interference of the resonant signals and the NRB. After NRB reduction, the major peak of DMSO was relocated at 2912 cm⁻¹ with a FWHM 30 cm⁻¹ with the second peak at 3000 cm⁻¹ appearing more significant. The intensity ratio between the two peaks was similar to that in the spontaneous Raman spectrum. For methanol (second trace from bottom), two major peaks were observed at 2780 cm⁻¹ and 2924 cm⁻¹ with a FWHM of around 45 cm⁻¹, which were slightly shifted from the peaks at 2829 cm⁻¹ and 2940 cm⁻¹ observed from spontaneous Raman imaging. For ethanol (third trace from bottom), while only one peak was observed in the raw data, three distinct peaks can be identified after NRB reduction. These peaks were also shifted towards lower wavenumbers as compared to the spontaneous Raman data and had different intensity trends. A similar peak shift was also observed for PDMS (third trace from top) towards slightly lower wavenumbers. For glycerol (second trace from top), no major peaks were expected but the FWHM of the spontaneous Raman spectrum was around 110 cm⁻¹ centered at 2915 cm⁻¹. Our measured spectrum of glycerol had a FWHM of around 110 cm⁻¹ centered at around 2940 cm⁻¹ (both before and after NRB reduction). Glass signals (top trace) had a slight increase over this range of wavenumbers, and the NRB reduction gave results of zero amplitude since it was assumed that there should not be resonances in the glass.

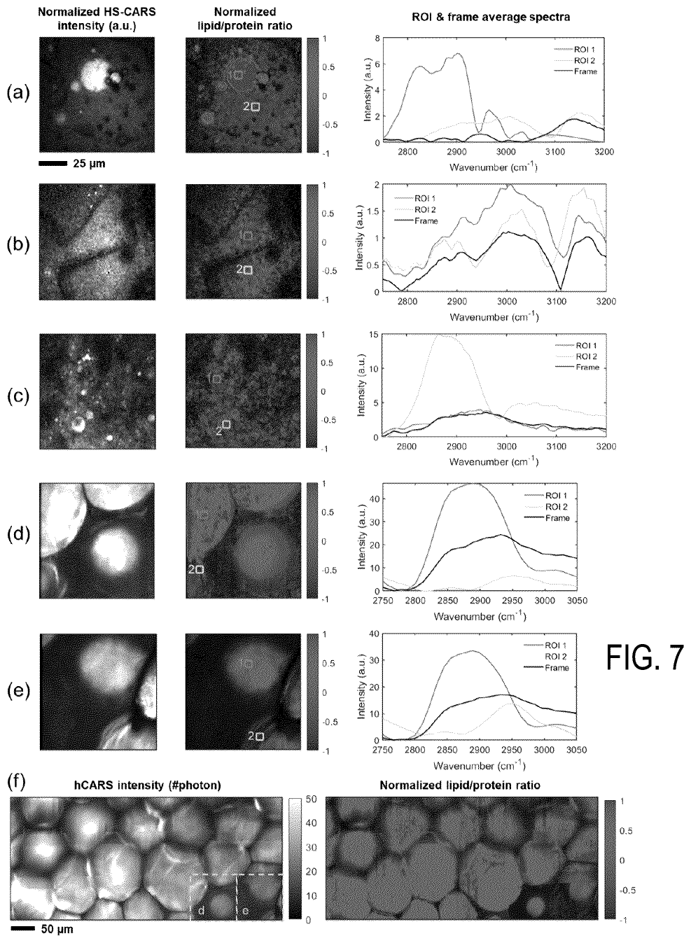

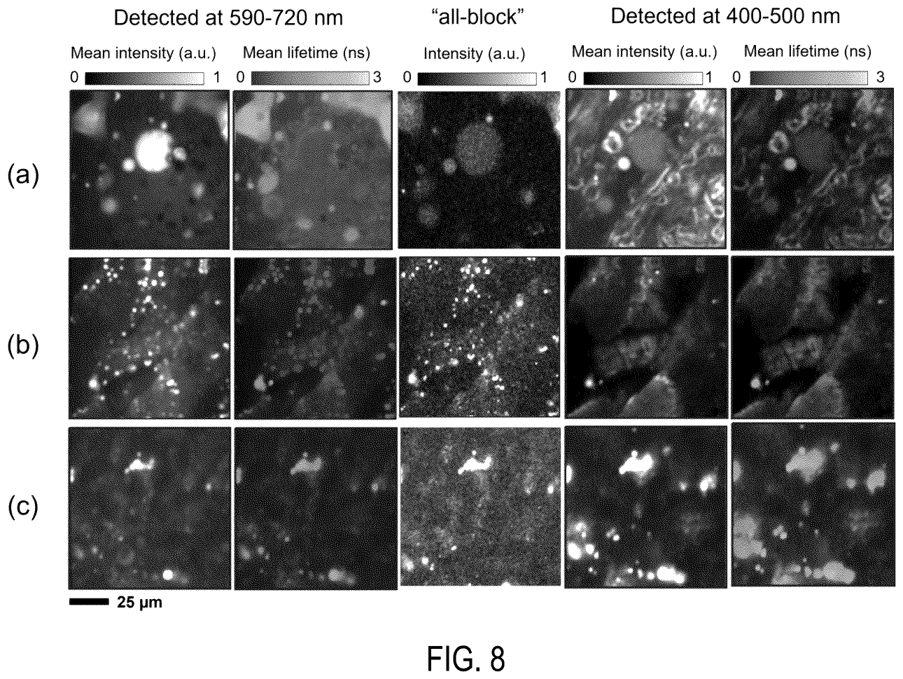

The ability of shaped-Stokes HS-CARS to capture chemical information in ex vivo biological tissue was demonstrated. FIG. 7 shows HS-CARS normalized intensity images averaged over the entire frequency sweeping range (grayscale, left column of rows (a) to (e)), the corresponding normalized lipid/protein ratio maps (blue-to-red map, center column of rows (a) to (e)), and representative spectra from regions of interest (ROI) (right column of rows (a) to (e)). Row (a) of FIG. 7 shows images that were acquired from a subcutaneous region in the mouse skin (abdominal region). A few small adipocytes (5-25 μm diameter) can be identified as the regions with the highest lipid-to-protein ratios. The protein-rich regions were composed of collagen fibers that were not resolved in the CARS image but were apparent in the spectrally adjacent autofluorescence channel (FIG. 8). Row (b) of FIG. 7 shows muscle with lipid droplets. Row (c) of FIG. 7 shows the liver with lipid droplets. Rows (d)-(f) show a subcutaneous region in the skin that was imaged with 31 different Stokes wavelength bands, covering a slightly narrower wavenumber range from 2750 cm⁻¹ to 3050 cm⁻¹. In particular, row (f) shows a large area mosaic showing multiple adipose, and rows (d, e) show selected FOVs of about 100 μm×100 μm in size. In rows (a-e), images were on the same scale (25 μm scale bar) and selected ROIs were all around 6 μm×6 μm. Differences in the CARS spectrum can be clearly identified in the selected ROIs between the protein-rich and lipid-rich regions. Lipids are expected to have a vibrational peak frequency in the CH-stretching region around 2850 cm⁻¹ and proteins at 2950 cm⁻¹. ROI 1a was selected inside an adipocyte and had 3-fold greater signals in the 2800 cm⁻¹-2900 cm⁻¹ range compared to the 2900 cm⁻¹-3000 cm⁻¹ range, whereas ROI 2a had constantly increased signals over 2800 cm⁻¹-3000 cm⁻¹, which was selected in the collagen-rich region. ROI 1b within the muscle tissue in row (b) of FIG. 7 had gradually increasing signals over 2800 cm⁻¹-3000 cm⁻¹ that were similar to the ROI 2a. In contrast, ROI 2b was selected from a lipid droplet that had a dip in signals at around 2940 cm⁻¹. Also, the overall signal strength was lower compared to the protein-rich regions (e.g., ROI 2a, 1b). In the liver tissue shown in row (c) of FIG. 7 with lipid droplets scattered across the FOV, ROI 1c was selected from the hepatocyte-rich region, which could be observed in the autofluorescence channel (FIG. 8). The CARS spectrum at ROI 1c showed an increase in signals from 2750 cm⁻¹ that peaked at 2950 cm⁻¹, which indicates that it is protein-rich. ROI 3c was selected from one of the lipid droplets and had significantly stronger signals in the range of 2850 cm⁻¹-2900 cm⁻¹, which validates that it is lipid-rich.

To demonstrate the fidelity of the system described herein, a large area mosaic of subcutaneous region within the mouse skin was also captured, with sparser spectral sampling (10 cm⁻¹) over a shorter range (300 cm⁻¹) (FIG. 7, row (f)). Selected FOVs that contain both lipid-rich and protein-rich structures are shown in rows (d) and (c) of FIG. 7. In contrast to the lipid content, the membranes of the large adipocytes were highlighted in blue in the lipid-to-protein map. Each hyperspectral data cube shown in this dataset was captured within 4 minutes, limited by the exposure time (12.8 μs) for sufficient number of photons collected from the samples.

FIG. 8 shows TSS-HS-CARS results of mouse tissue samples. Row (a) shows intensity and lifetime measurements for mouse skin, row (b) for muscle, and row (c) for liver at two spectral windows simultaneously. CARS signals were detected at 590-720 nm and another autofluorescence channel was detected simultaneously at 400-500 nm. Fluorescence lifetime values were retrieved from both channels. Since CARS is a parametric process, it should have zero fluorescence lifetime. However, practically it is non-zero and should approximate the temporal resolution of the system. For this system, a temporal resolution of around 230 ps was calibrated and reported. FIG. 8 shows the mean intensity and mean lifetime of the two channels for mouse skin, muscle, and liver, corresponding to the field-of-views (FOVs) in rows (a)-(c) of FIG. 7. Above, it was stated that the “all-block” mask was used to remove the autofluorescence component from the data. FIG. 8 shows that the all-block images contain the high-lifetime components of the FOV. Row (a) of FIG. 8 also shows collagen fiber structures in the 400-500 nm autofluorescence channel that matches the protein-rich region in row (a) of FIG. 7.

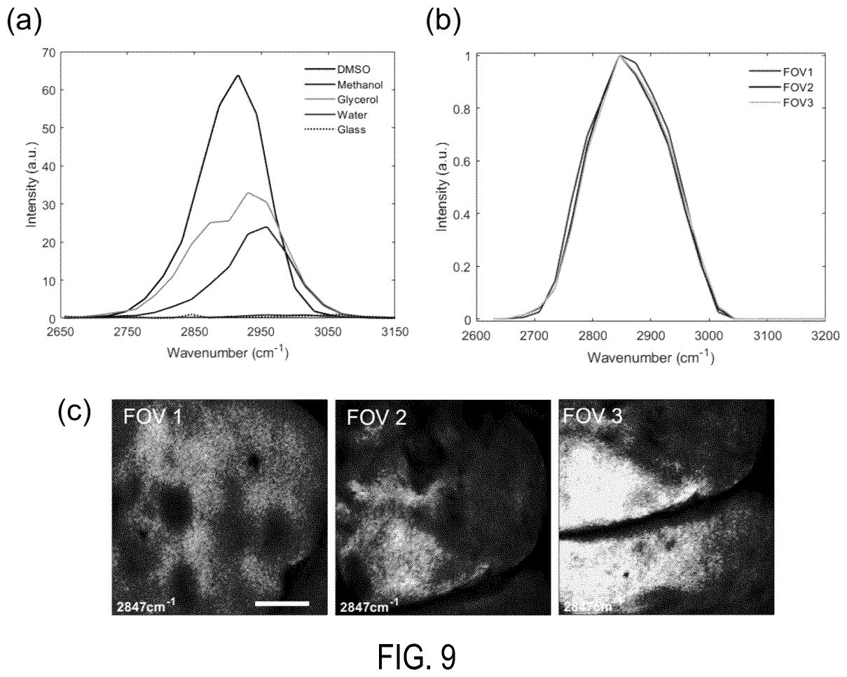

Herein, a concept for HS-CARS has been presented that has no moving parts, is adaptable to various acquisition schemes, and utilizes the exposure on the sample effectively with a customized and carefully calibrated FTPS. Several considerations led to the proposed HS-CARS method and the presented optical design. First is the preference of demonstrating this concept on CARS over SRS microscopy. Although SRS does not have an NRB and may, in some implementations, be computationally simpler and more accurate than CARS, it may also require modulation of the excitation beam which introduces more instrumentation complexity, higher power loss, and lower compatibility within a multimodal imaging system, especially in the epi detection configuration. Nonetheless, the method set forth herein can also be used in hyperspectral SRS imaging and generalized further to other spectroscopic techniques. Second, the feasibility of pump-shaping TSS-HS-CARS has been demonstrated (FIG. 9, discussed below), even though the Stokes-shaping method is the main example discussed herein. While a part of the better performance of the Stokes-shaping scheme can be attributed to the differences in optical components that affected the performance of the pulse shapers themselves, there is also a physical basis for this choice. CARS signal strength increases quadratically with the pump beam intensity and linearly with Stokes beam intensity; thus, a powerful and stable pump source may be favorable. Moreover, the pump wavelength is also tunable within the laser, which adds on more flexibility to select the targeted wavenumber range. By tuning the pump wavelength, finger-print region CARS is also feasible with minimal adjustment of the detection optics. The Stokes can be obtained by either the fiber continuum source pumped by the tunable or fixed output of the laser. However, this may require improved power efficiency and detection efficiency at CARS wavelengths. Furthermore, the pump beam can also be used to simultaneously excite two-photon fluorescence and second-harmonic generation, which can provide different contrasts from the same FOV in the sample and even simultaneously. Third, as previously mentioned, there are a few commercially available FTPS devices based on 2D SLMs. Many have restricted access to the SLM to impart the customized patterns utilized in this study. Nonetheless, FTPSs have utility for multiphoton microscopy and TSS-HS-CARS can fit into these modules. On the same note, the calibration methods presented herein provide a spectroscopic calibration of the intensity-to-phase values of the SLM. These improve the phase modulation and offer an improvement to any FTPS-based microscopy setup.

FIG. 9 shows the feasibility of pump shaping in chemical compound characterization and tissue imaging. In these experiments, 21 data points were collected by sweeping the pump from 782 nm to 818 nm which corresponds to a wavenumber range of 2655-3218 cm⁻¹ Raman vibrational frequency. Graph (a) of FIG. 9 shows the spectrum for DMSO, methanol, glycerol, water, and glass. Graph (b) of FIG. 9 shows porcine tissue imaging at 3 different FOVs. All FOVs have the same peak at 2847 cm⁻¹ and the images at the peak are shown below. The scale bar represents 25 μm. The Stokes beam came from the fixed output of the laser at 1045 nm. The FTPS in the pump beam path after the photonic crystal fiber (see FIG. 1) was used to sweep the pump wavelengths and match the bandwidth and the pulse width. Both beams were measured to be around 300 fs at the sample plane. As shown in graph (a) of FIG. 9, the pump shaping method can also distinguish different chemical compounds, but the spectral resolution was not as great as the Stokes shaping method demonstrated above (see FIG. 6). This could be improved by adding more dispersion (e.g., glass rods/blocks) to the beams. Graph (b) of FIG. 9 shows 3 FOVs in a fatty porcine tissue sample and the CARS signals peaked at 2847 cm⁻¹, which were also visualized in the images.

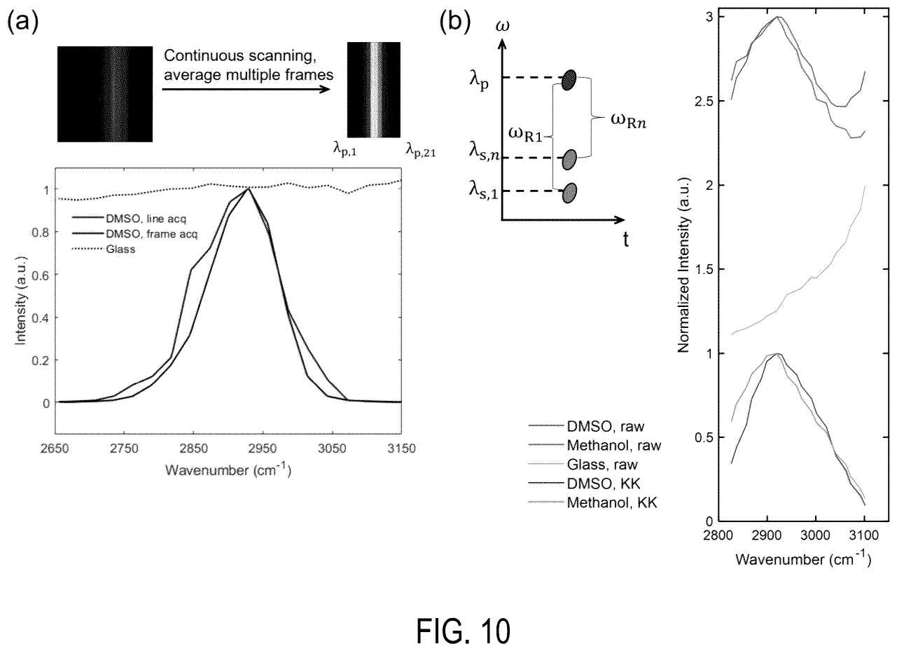

The results described above demonstrated HS-CARS using a frame-by-frame acquisition scheme, which is subject to motion-induced distortion. A lateral shift of 1˜2 μm was observed between the first and last frame of the data cube (acquired within 120 seconds) due to tissue relaxation. Although this shift is small (<5 pixels) and was compensated with a lateral median filter that was applied postprocessing, it can rigorously be corrected by image registration. However, the acquisition method is not limited to frame-by-frame capture of spectroscopic data. While the SLMs used the examples described herein had a slew rate of tens of milliseconds that restricted the operational speed to <60 Hz, ultrafast SLMs capable of 200 Hz operation are commercially available. The feasibility of synchronizing the SLM to multiples of the line clock has been shown in FIG. 10. This can be particularly useful for the fast characterization of pure chemical compounds or uniform samples. While pixel-to-pixel sweeping of the beams is theoretically feasible, the millisecond-scale pixel dwell time that it needs can be more prone to photodamage. Besides flexible acquisitions, the choice of shaped-Stokes wavelengths can be flexible according to users' needs. For example, one can choose to only collect data in the lipid region and the protein region for fast characterization of the lipid-to-protein ratio. The adaptability and flexibility of this method are not limited to data acquisition. Experiments were also performed with Stokes-shaping HS-CARS in the femtosecond regime, in which case simultaneous and optimized excitation of other multiphoton processes is possible.

Above, Stokes shaping results were demonstrated using frame-by-frame acquisition (i.e., x-y-f). The SLM can also be synchronized at the acquisition rate for a line or multiple lines for faster characterization of uniform and homogeneous samples such as pure chemical compounds. Graph (a) of FIG. 10 shows the multi-line synchronization results for imaging DMSO compared to frame-by-frame acquisition. The SLM was scanning at 3 Hz while the frame rate was 0.125 Hz. The multi-line acquisition gave similar results compared to the frame acquisition method. It was limited mainly by the signal-to-noise ratio and the response time of the SLM. FIG. 10 also shows the feasibility of implementing femtosecond TSS-HS-CARS. Graph (b) of FIG. 10, in particular, shows a diagram of femtosecond TSS-HS-CARS time-frequency distribution and CARS spectrum of DMSO, methanol, and glass, both with and without non-resonant background reduction. In the legend of FIG. 10, graph (b), “KK” refers to Kramer-Kronig relations. Both the pump (765 nm) and the shaped Stokes beams were around 180 fs at the sample plane. Theoretical spectral resolution under this configuration was calculated to be around 160 cm⁻¹. Graph (b) shows that this method can resolve the major peak of DMSO, but could not resolve dual peaks of methanol even after non-resonant background reduction. Both DMSO and methanol generated resonant signals whereas the glass did not. This method comprised the spectral resolution but can simultaneously generate other multiphoton contrasts (such as two-photon autofluorescence and second-harmonic generation) at a desired condition.

TSS-HS-CARS offers advantages over both SF-HS-CARS and LS-HS-CARS including high exposure utility, and fast and stable operation without any moving parts. The adaptive configurations enable multiple acquisition schemes limited only by the exposure time and the operational characteristics of the optoelectronic components. While the present disclosure provides examples of TSS-HS-CARS in three different schemes (Stokes-shaping, pump-shaping, and femtosecond-pulse with two different acquisition modes), there are more possible adaptations of this concept and improvements of the system. For better spectral resolution, for example, one can increase the chirp of both beams and include higher-order dispersion parameters into the model for generating the phase patterns. Moreover, adaptive acquisition enables better freedom in choosing the optimal point between speed and spectral resolution for simple ratiometric analysis or dynamic imaging applications. TSS-HS-CARS can enable rapid and specific chemical characterization of biological tissue and other materials with great adaptability and tunability.

Moreover, comparative implementations lack comprehensive excitation pulse programmability. Thus, the present disclosure further contemplates the use of a Fourier transform pulse shaper equipped with a 2D SLM for simultaneous phase and amplitude pulse shaping for programmable excitation in CARS microscopy. This enables the customization of a hyperspectral excitation envelope via amplitude selection and modification of the temporal overlap of the two excitation beams via phase shaping, which can be tailored for specific samples with a priori spectral information or used for adjusting the SNR, acquisition time, and/or spectral resolution of the system without a priori spectral information. This tunable excitation scheme of spectrally tailored CARS involves the use and creation of customized continuous hyperspectral excitation envelopes to enable more rapid and efficient collection of useful information compared to the comparative spectral sweeping.

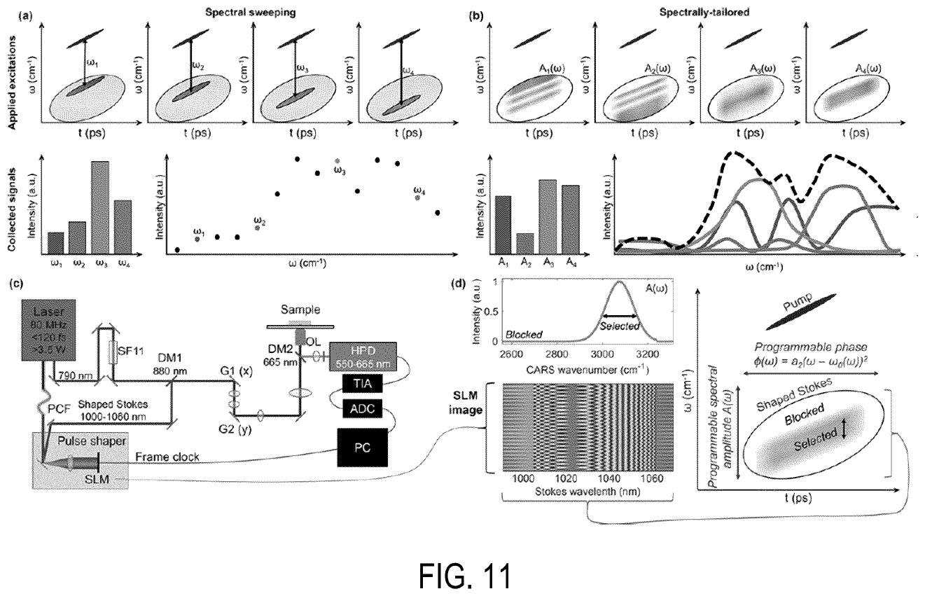

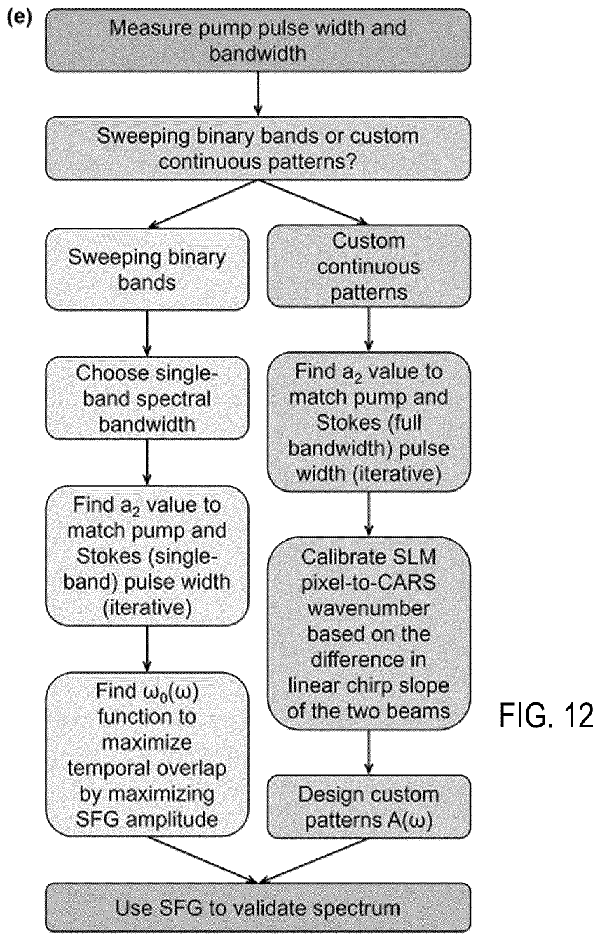

FIG. 11 illustrates an overview of spectrally tailored CARS. Diagram set (a) shows that, in the comparative example of spectral sweeping, the instantaneous energy difference between the pump and Stokes is equal due to their matched linear chirps. This difference is tuned to sequentially acquire distinct vibrational energies (ω). Each pixel of an HS image has one intensity value for each measured individual wavenumber. Diagram set (b) shows that, in spectrally tailored CARS, HS-CARS envelopes (A(ω)) are applied via shaping the Stokes beam, and one intensity value is recorded for each of the excitation envelopes for each pixel within the image. Diagram (c) is a system diagram, including pulse shaper and SLM. Graph set (d) shows an example of applied CARS envelope A(ω), corresponding the SLM pattern applied to the Stokes beam, and time-frequency plot of the excitation. FIG. 12 shows a flowchart of how SLM patterns were created for spectrally tailored CARS. In FIGS. 11 and 12, the following acronyms are used: PCF, photonic crystal fiber; SLM, spatial light modulator; DM, dichroic mirror; G, galvo; OL, objective lens; HPD, hybrid photodetector; TIA, transimpedance amplifier; ADC, analog-to-digital converter.

The system of FIG. 11 was described in more detail above with regard to FIG. 1, for HS sweeping using phase- and amplitude-based pulse shaping in TSS-HS-CARS. Briefly, the system used a dual output (1045 and 790 nm) 80 MHz laser (InSight X3+, SpectraPhysics) along with a photonic crystal fiber (LMA-PM-10, NKT Photonics) to generate a supercontinuum Stokes beam (200 nm base-to-base). The central region of the supercontinuum (1000-1060 nm) was shaped with a Fourier transform pulse shaper using a 1920×1200 pixel 2D SLM (SLM 200, Santec). Due to the linear dependence of CARS intensity on the Stokes intensity, shaping the Stokes beam was selected. Images of 400×400 pixels were acquired with a 3.2 μs pixel dwell time and 5.76 s per frame. A 1.05 NA water immersion objective was used (XLPLN25XWMP2, Olympus). A 665 nm dichroic (FF665-Di02-25×36, Semrock) was used to separate the excitation from the epi-directed CARS signal, which additionally passed through a short pass and a bandpass filter (FF01-665/SP-25, FF01-665/150-25, Semrock). Photon counts were determined via computational photon counting using a hybrid photodetector (R10467U-40, Hamamatsu). Power on the sample was 10-30 mW for the pump beam and <6 mW for the Stokes beam; the pulse width at the sample plane was 850 fs for the pump, and the temporal profile of the Stokes was shaped to match 850 fs by modifying the quadratic coefficient of the SLM phase mask as described in FIG. 12.

Various sets of SLM patterns were generated to shape the Stokes beam for customized excitation, as shown in graph set (d) of FIG. 11. Amplitude selection was achieved by applying horizontal lines along an axis orthogonal to the wavelength axis on the SLM to create destructive interference in the far field. Thus, an amplitude modulation function and a phase function are independently designed but simultaneously implemented (e.g., on orthogonal axes) on the SLM. These patterns included higher (spectral) resolution spectral sweeping, lower (spectral) resolution/higher SNR spectral sweeping, Fourier series components, and customized patterns tailored using a priori spectral information. Higher-resolution spectral sweeping patterns were generated by tailoring spectral bands of the Stokes beam to have the same spectral bandwidth and pulse width as the pump beam, thus ensuring the same linear chirp, and were assumed to be the ground-truth CARS spectrum. Lower-resolution/higher-SNR patterns were generated by selecting a spectral band twice as large as the high-resolution patterns and a pulse width that matches the pump to optimize power efficiency on the sample and excite a broader wavenumber region using the mismatch of the linear chirps, thus exciting more overall CARS signal.

Other customized patterns were generated by producing a broadband Stokes beam with the same pulse width as the pump and shaping the amplitude within that band by varying the intensity of horizontal lines. Patterns were validated with sum-frequency generation spectra at the sample plane using a spectrometer (USB4000, Ocean Optics), with a measured full-width at half-maximum at 450 nm of ˜2 nm. The limited spectral resolution after conversion to wavenumber (100 cm⁻¹) of the spectrometer limits the ability to validate higher spectral frequencies.

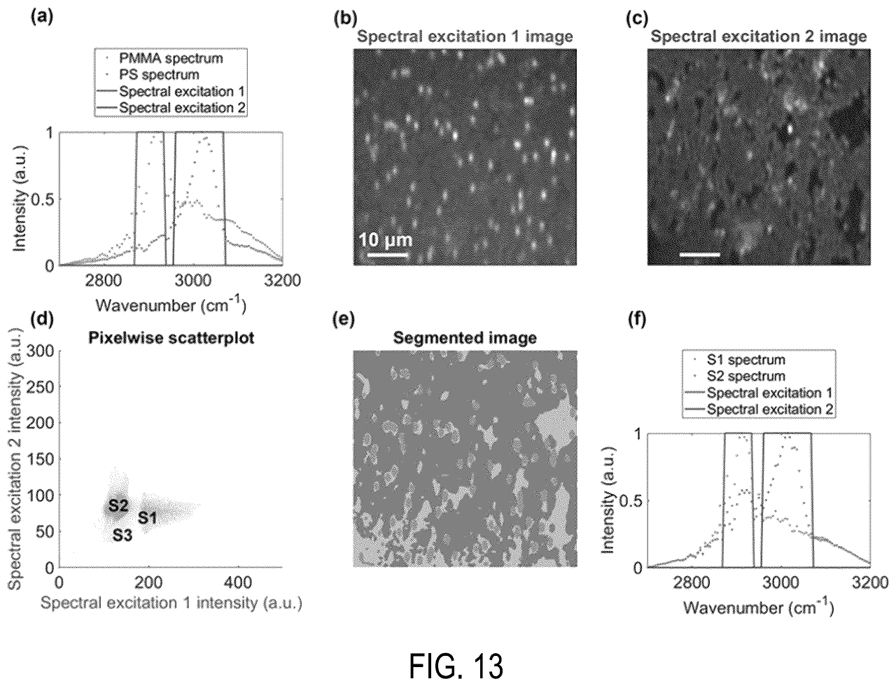

FIG. 13 illustrates an example of the differentiation of polystyrene (PS) and polymethyl-methacrylate (PMMA) beads using two tailored spectral masks. Graph (a) is a CARS spectrum from pure samples of each type of bead, along with custom masks design to specifically excite each type of bead. Images acquired from a mix of PS and PMMA beads using (image (b)) Mask 1 and (image (c)) Mask 2. Graph (d) is a scatterplot of pixelwise intensities of Mask 2 versus Mask 1, along with segmentation into three different spectral signatures (S1, S2, S3). Image (e) shows pixels corresponding to the spectral signatures in graph (d). Graph (f) shows HS-CARS data collected on the same FOV, displaying the spectra of segmented regions S1 and S2 in image (e). First, samples of two different types of beads were examined to observe system capabilities for differentiating and segmenting two chemically distinct substances. Pure samples of PS or PMMA beads (1 μm diameter) were characterized with higher-resolution spectral sweeping to determine the CARS signatures of the two beads, matching previously acquired spectra. From these pure spectra, two binary masks were designed to selectively excite PMMA (spectral excitation 1) and PS (spectral excitation 2). These custom spectral excitation envelopes were applied via the SLM to image a mixture of PS and PMMA beads. The mixture was also imaged with the set of higher-resolution sweeping patterns for validation. Images acquired using the custom spectral excitation envelopes (FIG. 2, images (b) and (c)) selectively highlighted subsets of beads. The pixelwise intensities from the two custom spectral excitation envelopes were visualized on a scatterplot (graph (d)) and used to segment three different regions: S1 (high spectral excitation 1 intensity), S2 (high spectral excitation 2 intensity), and S3 (background). The set of higher-resolution sweeping patterns was also acquired on the same FOV, and spectra from segmented regions S1 and S2 (graph (f)) matched well with the original PMMA and PS pure spectra (graph (a)), indicating that the custom pair of spectral excitation envelopes can be used for the segmentation of the two bead types with ˜ 1/50 total acquisition time of the spectral sweeping (2 patterns×5.76 s=11.52 s versus 101 patterns×5.76 s=581.76 s) and with 84% of PMMA pixels and 97% of PS pixels classified in agreement with using the higher-resolution patterns for segmentation, likely with decreased accuracy due to a small shift in the focal plane during the higher-resolution spectral sweep.

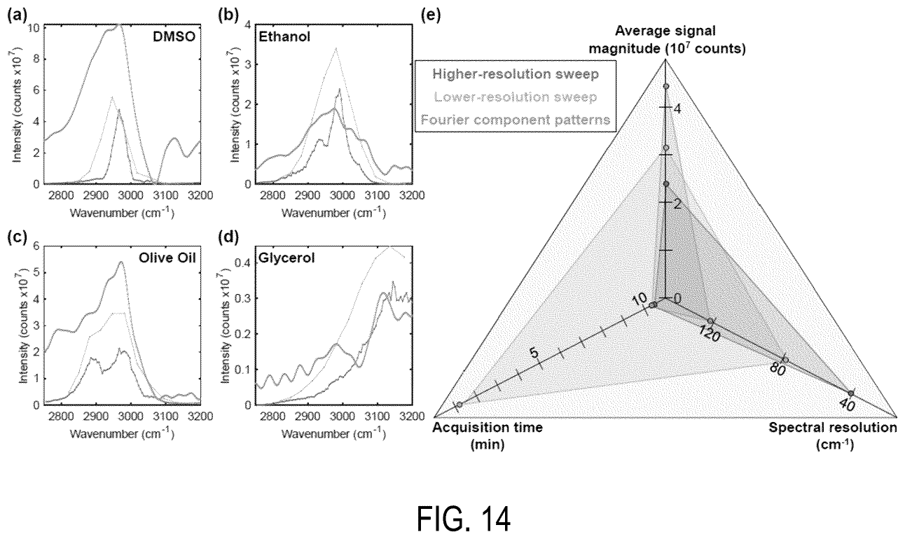

Next, the tunability of acquisition time, spectral resolution, signal magnitude, and SNR capabilities were examined. Three sets of excitation spectra were used: higher-resolution spectral sweeping, lower-resolution spectral sweeping, and Fourier patterns. The patterns were used to image DMSO, ethanol, and olive oil, along with the non-resonant background from the SF57 glass. FIG. 14 illustrates the four substances imaged with different tailored excitation schemes higher-resolution sweep (101 narrow patterns, 42 cm⁻¹ spectral resolution), lower-resolution sweep (11 broad patterns, 78 cm⁻¹ spectral resolution), and Fourier components (100 sine patterns with different phase shifts and frequencies). All three schemes were used to image pure solutions of, in graphs (a)-(d), DMSO, ethanol, olive oil, and SF57 glass for the non-resonant background, respectively. Diagram (c) presents a quantification of the trade-offs of the collected CARS signal magnitude (calculated as the difference between maximum and minimum spectral intensities), the spectral resolution (calculated as the FWHM of DMSO peak), and the acquisition time. As expected, the set of 11 lower-resolution patterns provided improved signal magnitude compared to the higher-resolution sweep due to the increased CARS generated from the larger spectral window. Due to the loss throughout the system, the maximum power of the shaped Stokes beam on the sample for one of the higher-resolution patterns is ˜3 mW, which increases to ˜6 mW with the lower-resolution patterns. By shortening the overall acquisition time with the lower-resolution pattern set, the contribution of dark counts to the overall signal is decreased, further improving the SNR. Often, higher spectral resolution is favorable; however, in scenarios where fast acquisition is essential, customized patterns can be created to have the broadest acceptable spectral bandwidth, maximum SNR, and fastest acquisition by programming the spectral bandwidth and chirp of the pulses for spectral sweeping; e.g., the demonstrated lower-resolution sweep (11 patterns) was acquired ˜9 times faster than the higher-resolution sweep (101 patterns) and provides useful spectral information.

The Fourier component basis (100 patterns) improved the signal magnitude for some samples and somewhat matched the shapes of the expected spectra. However, the spectra showed unexpected modulations, likely due to reconstruction errors, which could be affected by higher-order dispersion of the overall microscope. Higher-order dispersion compensation could be calibrated for sets of patterns and applied as part of the phase masks using the SLM. The trade-off between spectral resolution, acquisition time, and signal magnitude for the three tested sets of patterns is quantified in diagram (e) of FIG. 14. While the signal magnitude was the highest for the Fourier series components (4.4×10⁷ counts) compared to the lower-resolution (3.1×10⁷ counts) and higher-resolution (2.3×10⁷ counts) sweeps, when SNR was calculated as the mean ratio of the maximum value and the mean of a silent region from 3100 to 3200 cm⁻¹, the lower-resolution sweep provided the best SNR (95.5) compared to the higher-resolution sweep (64.0) and the Fourier component (9.9).

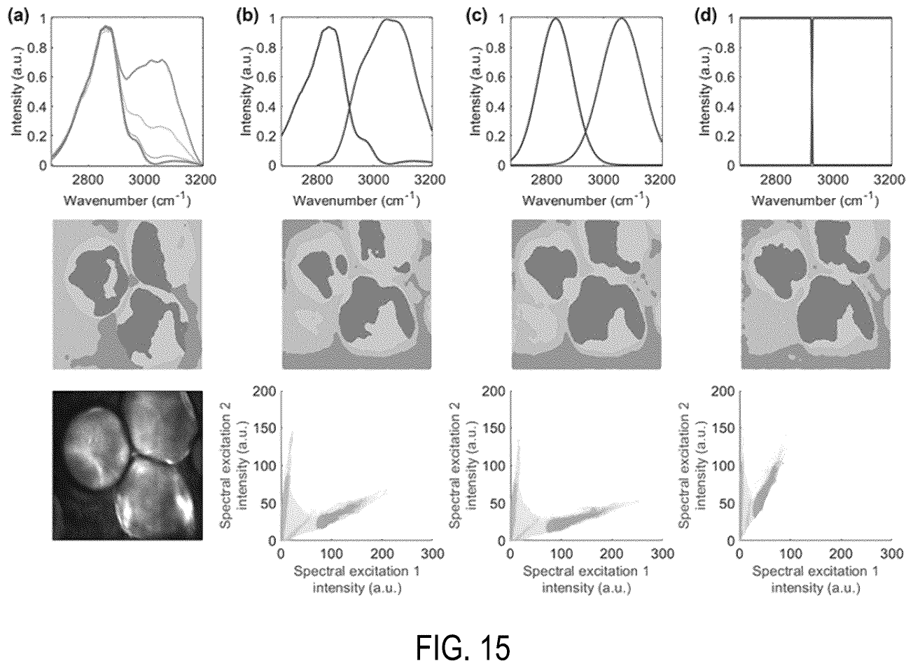

Ex vivo murine abdominal adipose tissue was imaged, motivated by the known Raman signature of lipids. All animal procedures were conducted in accordance with a protocol approved by the Institutional Animal Care and Use Committee (IACUC) at the University of Illinois Urbana-Champaign. To retrieve the ex vivo tissue, a mouse was euthanized by CO₂ asphyxiation and cervical dislocation, and a piece of skin was removed, including subcutaneous fat. FIG. 15 shows images to illustrate the effects of spectrally tailored CARS of adipocytes. Column (a) shows the overall CARS intensity of adipocytes, customized segmented regions based on high-resolution swept HS-CARS, and CARS spectra of different segmented spatial components. Different spectral excitation envelopes were applied: spectral components, Gaussians, and binary masks, as shown in columns (a)-(c), respectively. First, higher-resolution spectral sweeping was acquired on a FOV (column (a)), and four regions with similar spectra were segmented, two intra-adipocyte components (blue and green), and two extra-adipocyte components (yellow and orange). Multiple new pairs of excitation spectral envelopes were tailored and applied to the SLM for imaging based on the normalized spectra from the segmented blue region and the difference between the segmented blue and orange regions (column (b)), Gaussian fits to these spectra (column (c)), and binary masks (column (d)). Images were segmented to highlight similar regions based on manual tuning of linear boundaries between segmented areas in the pixelwise scatterplot; K-means clustering additionally yielded segmentation results.

Thus, the present disclosure further describes a proof of concept for spectrally tailoring CARS microscopy with programmable phase and amplitude and could be expanded in a variety of ways to improve performance and scope. While this example focused on the CH region (˜2700-3200 cm⁻¹), it may also be used in the fingerprint region, which is widely used due to its specificity for biomedical imaging, yet can present a challenge due to the lower signal intensity compared to the CH region. Furthermore, advanced methods for spectral decomposition and analysis could better define spectral basis functions, such as independent component analysis or weakly supervised learning. Thus, spectrally tailored excitation provides immense utility for improving acquisition and processing efficiency in well-defined HS imaging tasks. Conveniently, the system setup for spectrally tailored CARS is compatible with spectral sweeping. In this example, the impact of the CARS non-resonant background is reduced by the longer pulse widths and the epi-detection geometry. In other examples, the non-resonant contribution could be avoided by alternative pulse shaping methods, such as temporally delaying a probe pulse with a different wavelength than the pump.

### Example Implementation—Microscopy

The above description presents a technique (TSS-HS-CARS) that uses amplitude and phase pulse shaping of a supercontinuum to scan and match different pump and Stokes spectral windows, and a variant of the technique for a femtosecond pump pulse and a shaped supercontinuum Stokes pulse that could scan different spectral windows within the CH stretching region. The CH region has strong signals in biological samples and is useful in imaging and separating protein and lipid components. Considering the abundance of lipids in the brain, the addition of CARS to a multimodal scope will unlock avenues into structural and dynamic imaging of the neuronal environment. Thus, one example implementation of TSS-HS-CARS may be in establishing multimodal label-free optical tools for observing the activity of the neuronal microenvironment in action in its native state to fill knowledge gaps. Many comparative applications of optical microscopy in neuroimaging have been limited to the use of fluorescent labels or optogenetics. Label-free optical microscopy is less invasive, more versatile, and has a higher potential for future clinical translatability, which leads to the question—what are the label-free markers for the structural and functional dynamics of the neuronal microenvironment?

The ion flux that induces the electrical signals in a cell creates subtle changes to the cell refractive index and the local microenvironment. The mechanical action of these ion channels also deforms the cell membrane, which changes the local birefringence. While these changes are subtle, they can be measured using optical interferometry combined with polarization imaging. Second, active neurons have dynamic energy requirements; therefore, they experience rapid changes to their metabolic states. Cell metabolism involves several autofluorescent co-factors like reduced nicotinamide adenine dinucleotide (NADH) and its phosphorylated form (NADPH) or flavin adenine dinucleotide (FAD). Since the fluorescence lifetime of NAD(P)H and FAD are related to the metabolic state of the cells, fast fluorescence lifetime imaging microscopy (FLIM) can track these metabolic changes in real time. There are also local changes to the chemical environment because of neuronal electrical and metabolic activities; vibrational spectroscopy with coherent Raman imaging can characterize these changes rapidly. Measuring these physical and chemical changes using polarization imaging, functional optical coherence microscopy (OCM), FLIM, and Raman scattering microscopy provides an avenue for label-free optical measurement of the electrical activity of neurons.

The metabolism of neurons affects their activity and subsequent recovery. Metabolism and energy regulation in the neuronal microenvironment involve several parallel processes, such as the glucose transport and utilization for mitochondrial metabolism in the neurons and supporting glial cells, the astrocyte-neuron lactate shuttle, the metabolism of neurotransmitter synthesis, release, and uptake, and the energy required to drive the ion pumps to maintain homeostasis. Understanding the intricate interplay between these parallel processes may be used for unraveling the complexities of neurometabolism and its implications for brain function and health. Comparative metabolic profiling techniques, such as mass spectrometry-based metabolomics, allow the comprehensive analysis of small-molecule metabolites in biological samples. While comparative radiographic and Raman probes such as 2-deoxyglucose or deuterated glucose can track specific metabolic pathways, they lack the versatility to observe multiple parallel processes. As an alternative to imaging the glucose or lipid consumption, fluorescent redox probes such as Dihydroethidium, MitoSOX (for mitochondrial oxidative stress), or nitroreductase-based probes have been used for comparative metabolic imaging of neurons on a cellular scale. Redox pathways are involved in several metabolic processes in the neuronal environment. Most tags are designed to be specific to a small subset of these processes. However, imaging the cellular autofluorescence intensity and lifetime from metabolic co-factors such as NADH and FAD can also report on the redox state of the biological samples.

Due to their lengths and large structures, neuronal metabolism is compartmentalized, including the TCA cycle and the electron transport chain (ETC) in mitochondria, glycolysis related to membrane ion pumping, and glycolysis for pyruvate generation for further aerobic metabolism. Comparative studies have explored the change in the NADH and FAD fluorescence intensity during electrical activity. One such model suggested a decrease in the NADH levels following activation, followed by a prolonged increase to the overall NADH level before a return to baseline over several dozen seconds. There is also a notable change in the local lactate dehydrogenase (LDH) concentrations in neurons. Astrocytes were shown to not have this initial decrease, but just an increase in response to stimulation of neighboring neurons. There was also an overall increase in the tissue lactate concentrations. FAD autofluorescence intensity was shown to have the opposite dynamics of NADH in neurons. The shuttling of lactate between different cells in the neuronal microenvironment was observed with the Peredox sensor, which is sensitive to the cytosolic NAD⁺/NADH ratio.

A comparative technique for label-free imaging of neuronal activity involves optical coherence tomography (OCT) and its corresponding high-resolution variant OCM. Individual action potentials can be discerned from the light scattered at large angles or by differential detection of the membrane displacements from brightfield microscopy. Even long-term changes to the cellular potential have been tracked by phase-sensitive interferometry. Full-field interferometry, quantitative phase imaging, and digital holographic microscopy have also been used to balance the spatiotemporal range of the measured scattered optical field. Apart from changes to the refractive index, changes to the local birefringence also report neuronal activity. Comparative studies also found that changes to the birefringence are larger than the changes to the backscattered light due to axonal reorientation during changing membrane potentials, sometimes up to an order of magnitude. Certain fibers and matrix proteins also have second harmonic generation (SHG) signals, which arises from the nonlinear susceptibility of a material. SHG signal is spectrally separable from autofluorescence in multiphoton microscopy and is commonly implemented as an additional color channel in commercial microscopes.

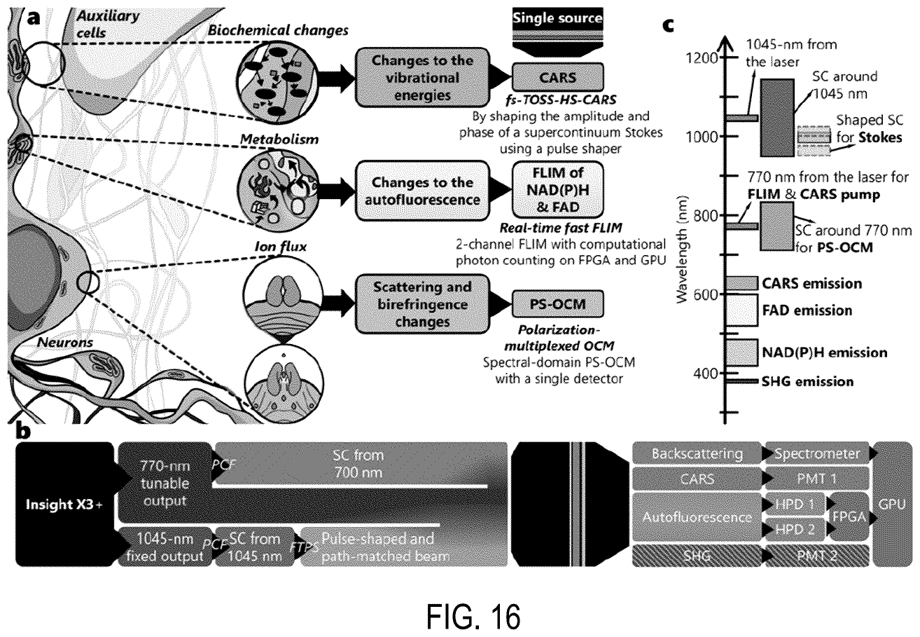

Thus, the TSS-HS-CARS techniques described above may be used to devise and establish a neuroimaging tool that can capture the structure, metabolism, and biochemistry of the neuronal environment over large scales and do so dynamically on the same timescale as neuronal activities. The versatility of this tool is ensured by engineering a single optical source to extract all contrasts simultaneously, the microscale resolution and imaging speed of each contrast, and the computationally accelerated excitation or detection of each modality for real-time imaging. This example implementation is referred to herein as Versatile Autofluorescence lifetime, Multiharmonic generation, Polarization-sensitive Interferometry, and Raman imaging in Epi-detection (VAMPIRE) microscopy as a solution to this problem. FIG. 16 illustrates the contrasts, spectral coverage, and system setup of VAMPIRE microscopy. Image (a) presents an illustration of the various physical, metabolic, and biochemical changes in the neuronal microenvironment and how optical microscopy modalities can access these contrasts. Image (b) presents a simplified schematic of the single source simultaneous detection in VAMPIRE microscopy, using the following acronyms: SC—supercontinuum, PCF—photonic crystal fiber, PMT—Photomultiplier tube, HPD—Hybrid photodetector, FTPS—Fourier transform pulse shaper. Graph (c) shows the spectral coverage of the excitation and detection in VAMPIRE microscopy, where the colors correspond to the colors of the light paths in image (b).

VAMPIRE microscopy utilizes three orders of light-matter interactions by evoking signals from the UV to the NIR from six processes simultaneously with a single laser, each accelerated using optoelectronic and computational techniques for fast imaging. Fast FLIM was implemented with computational photon counting on a field programmable gate array (FPGA) for 4× compressed sensing, followed by real-time processing on a graphical processing unit (GPU). Polarization-sensitive OCM in the spectral domain was achieved using a single detector through polarization multiplexing, followed by real-time processing on a GPU. Multispectral CARS with femtosecond pulses were achieved using TSS-CARS. Applications in supercontinuum generation on a photonic crystal fiber, amplitude and phase shaping on a Fourier transform pulse shaper, and effective utilization of the spectral windows were utilized to generate, optimize, and combine the excitation for each modality. First, dual-channel fast FLIM with computational photon counting on an FPGA is demonstrated as an effective tool for imaging neuronal metabolic dynamics. Next, the utility of VAMPIRE microscopy to visualize the large-scale brain and retinal microenvironments rapidly is highlighted. Third, the dynamic images of the ex vivo brain and the retina clearly show how the multidimensional information can be effectively utilized as a “functional contrast” for the components within the neuronal microenvironment, which would not have been possible without fast or simultaneous acquisition.

The photocurrent from a hybrid photodetector can be converted to photon counts with count rates of over 500% using a high-speed (GHz) digitizer, a hybrid photodetector (HPD), and the single-and-multi-photon peak event detection (SPEED) algorithm. In this example, the fast FLIM setup is expanded to two channels and the FPGA is utilized for compressed sensing. Since the photocurrents are not used further for FLIM processing anywhere in the pipeline, the compression can be considered lossless for its intended application.

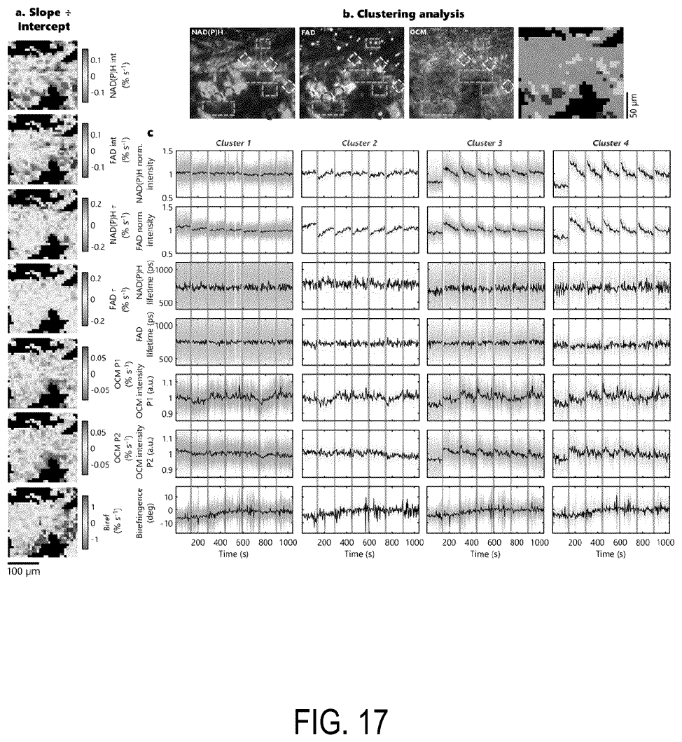

FIG. 17 illustrates the optical stimulation of retina ex vivo imaged with VAMPIRE microscopy. Graph set (a) shows the average normalized slopes. Image set (b) shows k-means clustering results based on the slopes and intercepts, and the interpretation in each modality. The regions that are prominent under cluster 2 are highlighted as rhombuses, cluster 3 are highlighted as rectangles, and cluster 4 as circles. Graph set (c) shows the individual (transparent and colored) and median (black and solid) trends of each contrast for each cluster.

The response to optical stimulation was analyzed by extracting the average slope and intercept for 25 samples following the excitation pulse for each super pixel (graph set (a)). The mean trends indicate that, despite changes to the fluorescence intensities in both the NAD(P)H and FAD channels, the changes to the overall fluorescence lifetimes, especially in the FAD channel, are minimal. Visually, some of the slopes in the OCM channel appear to be similar to the changes in intensities. The slopes normalized to the intercepts were used as inputs to the clustering algorithm. Cluster 1 represents background responses, with minimal changes to optical activation, except for some subtle changes to the FAD intensity. Cluster 2 represents responses from cells with an immediate decrease in the NAD(P)H and FAD intensities following optical activation, followed by recovery to the original intensity values. The responses in the FAD channel are repeatable for every optical activation, whereas the responses in the NAD(P)H channel progressively decrease in magnitude for every excitation pulse. A similar trend is observed in the OCM intensity channel, which only shows a response for the first excitation pulse. Clusters 3 and 4 are from regions that show an immediate increase in the fluorescence intensities of NAD(P)H and FAD following each excitation and recovery to lower intensities. The NAD(P)H intensities are expected to return to baseline values in 218 s and 185 s, for clusters 3 and 4, respectively, and 267 and 140 s for clusters 3 and 4, respectively, for the FAD intensities. The OCM intensities in both polarization states also show responses to optical stimulation in response to each excitation pulse. This also suggests a change to the overall cellular morphology in these regions. The different fall times in the intensities also suggest different metabolic states for these cells following neuronal activations.

Graph set (c) also shows the various clusters highlighted in the different modalities. First, cluster 3, in which both the autofluorescence intensity and OCM intensity respond to the optical excitation, appears to contain the ganglion cells with a visible nucleus within the FOV. While cluster 4 has a similar temporal response to cluster 3, it is made of sub-cellular (5-μm large) structures with bright autofluorescence in both NAD(P)H and FAD channels. Cluster 2 appears similar to cluster 3 structurally in the FAD channels as ganglion cells with a bright nucleus. This highlights how imaging with VAMPIRE microscopy can discern functional contrasts between neuronal subtypes. It should be noted that when the clustering algorithm was run on each individual channel, the “functional contrast” was not as informative as utilizing the multimodal data. The retina did not have sufficient CARS signals at the imaging speeds. However, the neuronal microenvironment of the brain is denser and has more lipids. The brain is also more scattering than the retina, causing higher CARS signals in the epi direction. This enables rapid characterization of the diversity within the neuronal microenvironment of the cortex in the mouse brain presented below.

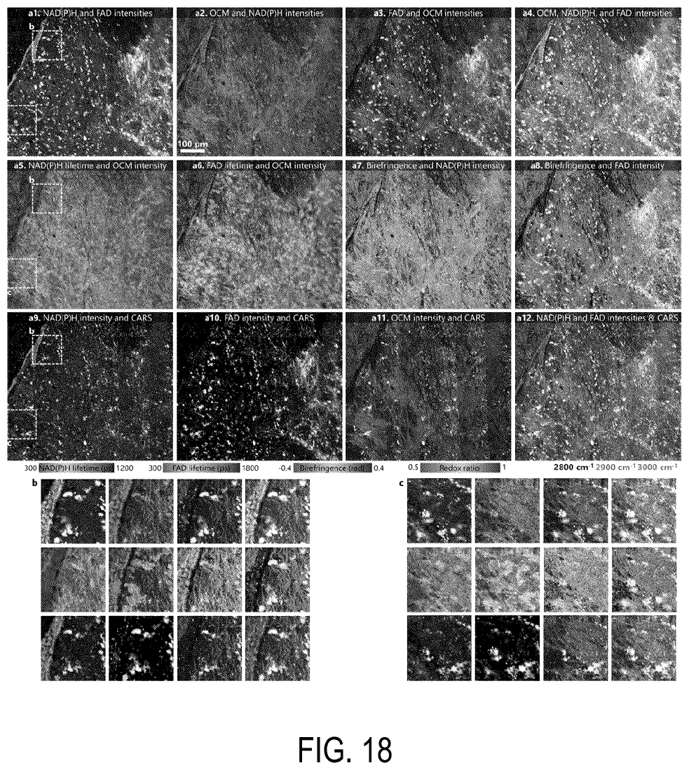

FIG. 18 shows a series of images of a mouse brain slice near the cortex using the VAMPIRE microscopy technique. Image set (a), at top, shows a 6×6 mosaic spanning 700×700 μm with two regions zoomed in. Image set (b), at bottom left, shows the zoomed-in region highlighting a blood vessel in the field, and image set (c), at bottom right, shows the zoomed-in region highlighting dense neuronal fibers. Each panel in the mosaic of FIG. 18 is a 24-frame average (8 frames for each spectral window in CARS). The blood vessel content of image set (b) is less scattering than the surrounding neuronal fibers in the OCM channel and has minimal CARS signals. However, the individual blood cells are apparent in the NAD(P)H and FAD channels. OCM can capture the micron-scale neuronal fibers within bundles; these regions also have high birefringence compared to surrounding areas. While some of these fibers are visible in the NAD(P)H channels, a majority of the autofluorescence is localized to a few regions within these tissues, which also coincides with the strong signals from the CARS channels. This further reiterates the compartmentalized metabolism of neuronal tissues. The speed and multidimensional information available through VAMPIRE microscopy provide insights into the neuronal microenvironment.

Next, the dynamics of the brain within the cortex region were explored. The neuronal microenvironment of the brain differs drastically from that of the retina, especially apparent in the OCM channels. More neuronal fibers and bundles were apparent within the FOV. A few cell bodies were apparent in the NAD(P)H and FAD channels. The range of birefringence was also larger than that of the retina, due to the ordered and denser alignment of the neuronal fibers. Several lipid particles are apparent in the CARS channel (as bright green dots), which coincide with bright spots either in the NAD(P)H or the FAD channels. They also have lower fluorescence lifetimes compared to the rest, typical of lipids. The change to the slope in the brain appears to be less than that in the retina. Nonetheless, the shifts are not monotonically increasing or decreasing for the entire FOV, negating the presence of any global trends. The intercepts are also fairly consistent across the entire time scale. This demonstrates the noninvasive nature of VAMPIRE microscopy and its capability to observe the dynamics of neurons over 1000 seconds.

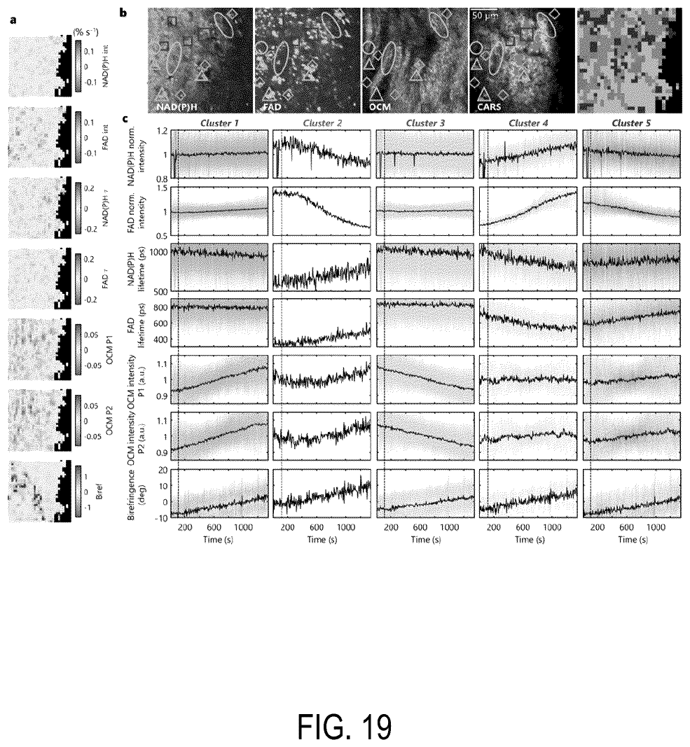

FIG. 19 illustrates the fast imaging of neuronal activity in the brain using VAMPIRE microscopy. The average slopes normalized to the intercepts are shown in image set (a). Image set (b) shows k-means clustering results based on the slopes and intercepts, and the interpretation in each modality. Five distinct populations were observed in the clustering analysis. The regions prominent under cluster 1 are highlighted as circles, cluster 2 as triangles, cluster 4 as rhombuses, and cluster 5 as rectangles. In graph set (c), the individual (transparent and colored) and median (black and solid) trends of each contrast for each cluster are shown. Clusters 1 and 3 had minimal changes throughout the fluorescence lifetime channels, although they had opposing trends in the OCM intensity channel. However, this does not appear to be a response to the addition of glutamate; rather, it is an effect of continuous imaging due to tissue relaxation. The average fluorescence lifetime of both clusters is also higher than the other clusters. Clusters 2, 4, and 5 are initially silent and respond after the addition of glutamate in both fluorescent intensities. The response of cluster 2, a decrease in the fluorescence intensities of FAD and NAD(P)H, is particularly delayed by over 200 s, suggesting a delayed onset of the effect of glutamic acid addition. In contrast, both clusters 4 and 5 respond to glutamate stimulation within 20 seconds. There is also an overall change to the fluorescent lifetime values. The most prominent changes are apparent in the FAD intensity and OCM intensities, which are also apparent in the slopes of image set (a). The molecular origins of these changes were also investigated with CARS imaging. The CARS images were acquired for 5 different spectral sub-bands of the Stokes beam to generate CARS signals at 2830 cm⁻¹, 2930 cm⁻¹, 3030 cm⁻¹, 2800-3100 cm⁻¹, and block (generated by creating destructive interference of all wavelength components in the 1045-nm supercontinuum using the pulse shaper). Since the individual responses in each frame were weak, the signals were analyzed across 4 larger time bins. First, TSS-HS-CARS in VAMPIRE microscopy could image the brain biochemistry label-free over long durations. Second, the three different vibrational bands captured highlight different parts of the sample. Third, with ratiometric analysis, there is an increased occurrence of pixels with very low or very high lipid-to-protein ratios.

The relationship between the time-series imaging, clustering analysis, and the sample structures is presented in graph set (c). Cluster 1 is prominent along a subset of the neuronal fibers apparent in the OCM channel. In the CARS images, these regions neither have a dominant protein peak nor a lipid peak. These regions do not have strong autofluorescence either, suggesting that these correspond to bundles of nerve fibers. Therefore, the changes observed in the OCM channels in these regions could be attributed to subtle shifts in the focal plane, where the scattering of the fiber bundles could be different within a small axial range due to the thin aligned structures. While clusters 2, 4, and 5 responded to glutamate stimulation, they have different biochemical and metabolic properties. For instance, cluster 2 (triangles) contains strong lipid peaks observed in the CARS channel, which also have strong NAD(P)H and FAD fluorescence. While clusters 4 and 5 appear alike in the OCM and autofluorescence channels, cluster 5 (squares) has more lipid content than cluster 4 in the CARS channel, though weaker than cluster 2. Tracking these regions in the CARS channel across time, these lipid particles appear only in the later frames, suggesting synthesis in response to neural activity.

The combination of these modalities, along with the clustering analysis, not only serves as a method to get functional contrasts between the different components of the tissue but also helps interpret the metabolic trends more accurately with the structural and biomedical contexts. The speed and non-invasive nature enabled long-term fast imaging of neuronal tissues in their physiological conditions label-free and rapid characterization of neuronal tissues over a larger FOV with sub-micron resolution completely label-free with a single tool. In this multimodal system, the cost is dominated by the femtosecond tunable dual-output laser. As an added advantage, the single source excitation, enabled by recent advancements in supercontinuum generation and pulse shaping, aid in synchronization and avoids the costs for additional sources for the other modalities.

The autofluorescence from neurons and neuronal tissues is weaker than other cell types. For instance, the average intensity (in measured photon counts) in the NAD(P)H channel per single laser pulse at the same power was 0.42 for a sample of a mouse kidney, 0.81 for a sample of a rat tail, 0.33 for a sample of a mouse heart, and <0.02 for mouse brain and retina. Similarly, for cancer cells (MDA-MB-231 cell line) imaged with the same setup, the average photon count ranged from 0.3 to 2.00 (up to 3.00) per laser pulse, whereas, for the neuronal cells, it was between 0.015 and 0.05. This 20× reduction in the autofluorescence intensity demands higher exposure times (more laser pulses incident per pixel). Neurons are highly metabolically active and possess efficient mitochondrial functions. Neuronal mitochondria exhibit efficient electron transport and lower levels of oxidative stress, resulting in reduced autofluorescence from mitochondrial fluorophores. Additionally, neuronal tissue has a relatively low concentration of endogenous fluorophores compared to other tissues. The lower concentration of these fluorophores in neurons results in reduced autofluorescence signals. The lower autofluorescence intensity also creates issues in the estimation of fluorescence lifetime values; more photons have to be considered to accurately estimate the fluorescence lifetime. Therefore, the imaging speed in this paper was between 0.05-1 Hz. This is slow even for Ca²⁺ dynamics, although fast enough to capture previously reported metabolic changes from neuronal activity. While computational photon counting with SPEED for FLIM improved the overall dynamic range of acceptable photon counts and the imaging speeds, the fundamental limitation was the low autofluorescence within the sample itself. In this example, the shortest pulse width at the sample plane with the multiphoton laser was 170 fs. With better laser sources, this could be further compressed to sub 100 fs for a 2-4× improvement in the signal levels.

CARS microscopy of neurons had a similar limitation as autofluorescence. The signal levels were estimated to be between 0.05 and 0.2 photons per laser pulse, of which a non-negligible portion is from the non-resonant background. Additionally, in the prototype TSS-HS-CARS setup in this example, the maximum power at the sample plane in each sub band of the Stokes beam was less than 3 mW. In this example, the photonic crystal fiber (PCF) was pumped at 60% of the maximum output of the laser because pumping it at higher powers caused back reflections that caused instabilities with the laser cavity. With improved laser design and isolation, this power could be increased further. Improving the efficiency of supercontinuum generation and the pulse shaper could help improve the signal levels of CARS and enable faster imaging. Additionally, for hyperspectral data, the Stokes pulses were varied between 4-6 patterns, thereby restricting the effective speed of HS-CARS to be less than the other modalities. CARS microscopy was used to characterize the dynamics in the samples in this paper. Raman scattering microscopy in the neurosciences in more prevalent for studying the pathways behind neurodegeneration, neuroinflammation, and injuries.

The weaker signals from these samples necessitated cumulating responses from several individual pixels into superpixels. While the structural imaging yielded images with diffraction-limited resolution in each modality, the effective resolution of dynamic imaging was reduced. For the same image dimensions, the effective resolution could be improved by scanning a smaller field of view. The fields of view in this example were chosen to ensure minimal photodamage during dynamic imaging such that the illumination is not persistent at any single location in the sample at the specified optical powers. The tradeoff between the field-of-view (and, consequently, the effective resolution) and the optical powers could be tuned based on the application. For instance, for more scattering samples or samples with higher CARS signals, the Stokes and OCM powers could be reduced with a corresponding increase in the pump power for stronger autofluorescence.

The systems and methods set forth herein provide for optical multimodal imaging with the combination of extracting the polarization, scattering, autofluorescence lifetime, and coherent Raman scattering at multiple vibrational energy levels. The combination of two-photon FLIM with multispectral CARS simultaneously has been a long-standing challenge at higher frame rates since comparative methods either need longer exposure times if one were to use femtosecond pulses with spectrometer-based CARS detection or weaker signals if one were to use picosecond pulses for spectral-focusing CARS. The techniques in VAMPIRE overcame this issue in the comparative examples. Comparative optical multimodal platforms could only do a subset of these contrasts, sometimes simultaneously.

The above description explores the utility of label-free multimodal optical microscopy for imaging neuronal structure and activity. Several label-free contrasts, used to study neural activity in comparative examples, were made faster, combined for co-registered multimodality correlations, and modified for imaging neuronal samples across a large spatiotemporal scale. In the field of quantitative electrophysiology with label-free imaging, the techniques presented in herein could observe spontaneous activity, responses to chemical stimulation and suppression, and responses to optical excitation. This is a key step in the paradigm shift from low-throughput electrophysiology to high-throughput optophysiology for fundamental neuroscience and clinical applications. For instance, Alzheimer's disease (AD) is a neurodegenerative disorder known to progressively cause memory deficits and broader cognitive impairment as the disease progresses. Post-mortem, AD is verified by the presence of hyperphosphorylated tau in neurofibrillary tangles and amyloid beta (Aβ) plaques, detected by immunohistochemical staining of the brain tissue. It is commonly believed that, collectively, the accumulation of these in the brain impairs neuronal function and communication, which eventually manifests into severe dementia as patients age. Label-free optical imaging presents a powerful and convenient means for identifying these biomarkers, tracking disease progression, and determining disease severity.

As a research system, the optical platform presented here can be used for other applications, including cancer biology and for biofilm imaging, since these label-free contrasts are ubiquitous among biological samples. Additionally, adaptive optics have demonstrated utility in similar multimodal systems, which can be adapted to VAMPIRE microscopy. This, combined with the epi detection, also enables in vivo imaging experiments with minimum modifications. While the individual modalities are present in clinical imaging, this example highlights the advantages of combining these modalities, with minimal additional cost for the laser sources. The complexity in the optical design and processing could be controlled based on application and making the components more modular.

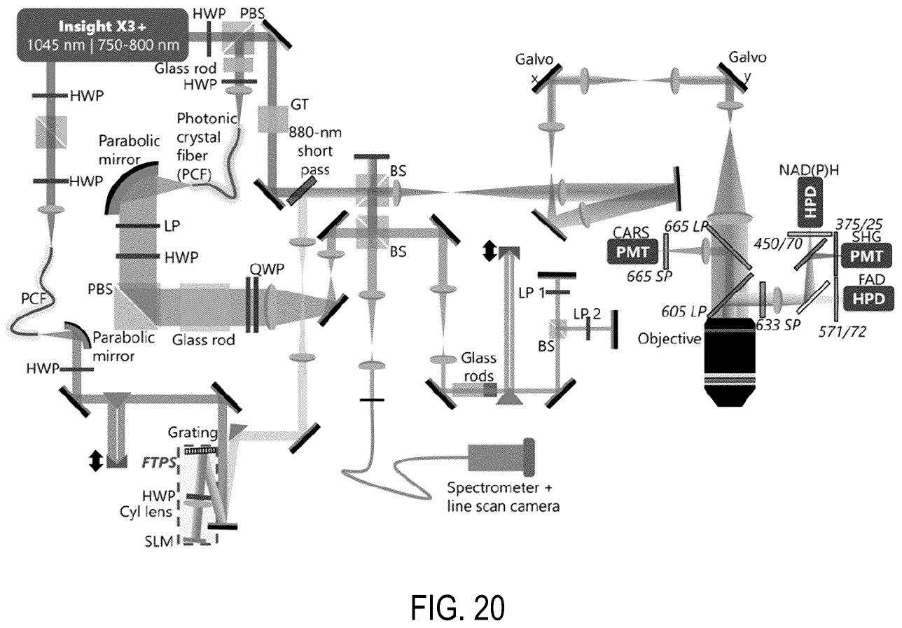

FIG. 20 illustrates an example system setup for VAMPIRE microscopy. In FIG. 7, the following acronyms are used: HWP: Half wave plate, PBS: Polarizing beam splitter, GT: Glan-Thompson polarizer, SLM: Spatial light modulator, BS: Beam splitter cube, LP 1,2: Lincar polarizer, Galvo: galvanometer scanning mirror, PMT: Photomultiplier tube, HPD: Hybrid photodetector, #SP/LP: Short-pass/long pass filter with cutoff at #nm.

The example system employs a titanium-sapphire laser (Insight X3+, Spectra Physics) as the excitation source for the multiphoton imaging system. The titanium-sapphire laser (Insight X3+, Spectra-Physics) was operated at a central wavelength of 770 nm and 80 MHz. The shortest pulse width at the sample plane was measured to be 170 fs. A 605-nm dichroic mirror (FF605-Di01, Semrock Inc) was used to separate the excitation and emission light, and a 505-nm dichroic mirror (DMLP505R, Semrock Inc) was used to separate the NAD(P)H fluorescence from FAD or Calbryte 590 AM fluorescence. A pair of 633-nm short pass filters are placed in the detection path before the 505-nm dichroic to prevent any excitation light leaking into the detector. When imaging Calbryte 590 AM fluorescence, a 665-nm dichroic mirror (FF665-Di01, Semrock Inc) and a 585-nm long pass filter were used in the Calbryte 590AM detection path and a 450±70-nm filter was placed in the NAD(P)H detection path. This path can be discerned by following the corresponding paths in FIG. 20. The SHG signal was detected using an analog PMT (H10721-210, Hamamatsu), amplified by a transimpedance amplifier (TIA-60, Thorlabs Inc.).

A part of the 770-nm beam is used to pump a PCF (LMA-PM-5, NKT Photonics) for an output power of 300 mW and a bandwidth of 120 nm (base-to-base). The output of the PCF is collimated with a parabolic mirror for an initial beam diameter of 12 mm and linearly polarized with a linear polarizer. This beam is directed into the interferometer directly after passing through a quarter wave plate and 0.2× magnification. The OCM beam is combined with the Stokes and pump beams using a cube beam splitter. Polarization-sensitive OCM was enabled using polarization delay multiplexing in the reference arm. This can be discerned by following the gray path in FIG. 20. The combined OCM beam underfilled the back aperture of the objective lens by design for higher depth of field.

The differences between spectral focusing CARS and TSS CARS, and the advantages of the latter are discussed in detail above. A supercontinuum spanning 200 nm base-to-base was generated by 1.3 W of 1045 nm output was coupled into a photonic-crystal fiber (PCF, LMA-PM-10, NKT Photonics). The custom FTPS (Fourier Transform Pulse Shaper) consists of a diffraction grating, an achromatic half-wave plate, a cylindrical lens, and a 2D spatial light modulator (SLM). The shaped Stokes beam was coupled into the pump path using a dichroic mirror after matching both polarizations using a half-wave plate. The collimation of the Stokes beam was adjusted to ensure that the focal spot of the two beams was at the same plane in the sample. An optical delay line (ODL) was inserted between the PCF and the FTPS to delay the shaped Stokes beam by 1 laser pulse period (12.5 ns for 80 MHZ) compared to the pump. The path lengths were matched by maximizing the sum-frequency-generated response from the interaction of the pump and the Stokes beam for a BBO crystal placed at the sample plane. The CARS emission was separated by a 665-nm dichroic. A 665-nm short pass filter (633SP, Semrock Inc) is placed in the detection path for CARS and a 612/69-nm filter was used before the detector. This can be discerned by following the corresponding paths in FIG. 20.

The beam is scanned by a pair of galvanometer mirrors (6220H, Cambridge Technology) and focused through a 25× Objective lens (Olympus Inc). The fluorescence photons were detected using a pair of hybrid photodetectors (R10467U-40, Hamamatsu Inc) which had a sub-500-ps rise and fall time. The photocurrents were amplified using a transimpedance amplifier (TIA, has-X-2-20, Femto). The OCM interferogram was captured using a fiber-based spectrometer (Cobra S 800, Wasatch Photonics) and one of two line scan cameras (OctoPlus, Teledyne e2v; or Sprint spL4096-140 km, Basler Inc.). The CARS signal was detected using an analog PMT (H16722P-40, Hamamatsu), amplified by a transimpedance amplifier (TIA-60, Thorlabs Inc.).

The output photovoltages were measured with a 5-GHz two-channel digitizer (ADQ7WB, Teledyne SP Devices) purchased with the additional development kit offering access to the onboard FPGA. The FPGA was programmed with Vivado 11 (Xilinx). A PCIe-based DAQ card (NI 6353, National Instruments) was used to generate the clocks, triggers, and the analog waveforms to control beam scanning. The same DAQ was used to capture the SHG and CARS signals through analog inputs. Both the digitizer and the DAQ card were synchronized to the laser using a 10-MHz reference clock derived from the internal photodiode of the laser passed through a clock divider (PRL-260BNT, Pulse Research Lab) and a fanout buffer (PRL414B, Pulse Research Lab). Since 5 GHz is not divisible by 80 MHz, there are 125-samples collected per two-laser periods and are processed together for phasor analysis for two cycles of the laser period. The OCM camera was connected to a PCIe-based frame grabber (NI 1433, National Instruments) and synchronized with the DAQ card for each line scan. The transverse resolutions of the fluorescence channels were 0.4 μm and 1.2 μm for CARS, limited by the NA of the objective lens. The transverse resolution of OCM was 1 μm (since the back-aperture was underfilled) and the axial resolution was 2.9 μm in the immersion medium (limited by the spectral bandwidth of the OCM source).

A custom LabVIEW acquisition software was used to acquire the data, with custom C-based programs to control the digitizer and the GPU modules. The software consists of three asynchronous modules. The first module generates the clocks, controls the motorized sample stages, handles the analog inputs for the SHG and CARS signals, and monitors for errors in the subsequent modules. The second asynchronous module controlled the digitizer and real-time display for FLIM, and the third module for OCM acquisitions. Queue buffers were set up on LabVIEW to asynchronously pass each line from the digitizer memory to the GPU memory via the RAM for both FLIM and OCM. Separate streams on a single GPU (GeForce 2080 RTX, NVIDIA Corporation) were used for real-time processing of the photon counts to fluorescence lifetime values based on an algorithm for each channel using phasor analysis and OCM reconstruction using matrix multiplication using the CUBLAS library. The fluorescence decay for each channel, the phasor components, the intensity, and the lifetime were saved for each channel as binary files. The raw OCM data and the analog input voltages (as 16-bit integers) were also saved in binary files. Custom MATLAB scripts were used to read in these images for generating the images discussed herein and for further analysis.

As noted above, all animal procedures were conducted in accordance with protocols approved by the Illinois Institutional Animal Care and Use Committee at the University of Illinois at Urbana-Champaign. All experiments in this example were conducted in compliance with the ARRIVE guidelines. Freshly extracted retinae from a 3-month-old albino mouse following euthanasia by CO₂ asphyxiation were placed in imaging dishes with freshly prepared and pH balanced Ames' medium within a stage top incubator mimicking physiological conditions. The images were acquired at 0.3 Hz. A 470-nm LED (M470F1) was focused onto the sample over a circular region of 5-mm radius for a total power of 10 mW, triggered using a microcontroller (Lab Jack U12). The same controller was used to trigger the shutter placed in front of the HPDs to block the light to the detectors when the LED is turned on. Images were acquired over 1000 seconds with 6 optical excitations in between (10 seconds on time and 140 seconds between two excitation pulses).

For a more detailed analysis, the relative slopes were input as an N-dimensional feature vector for k-means clustering. The number of clusters varied between 3 and 8, the value of 4 was chosen because it was the maximum number of clusters where no two median responses in more than 3 channels had an absolute correlation coefficient greater than 0.5. The four clusters, therefore, yield four unique responses within the sample.

The mice (3-month-old females) were euthanized with isoflurane overdose and decapitation, following which the brain was removed and placed in a cutting solution. The brain was sliced into 0.5-mm-thick slices and placed in an external solution for electrophysiology. The slices were placed in a stage-top incubator with physiological conditions (37° C. and 5% CO₂). The slices were imaged within 1 hour of extraction. The images were acquired in two different imaging conditions: high-speed and high-resolution. The high-speed images were acquired at 0.20 frames per second, and the high-resolution images were acquired at 0.055 frames per second, each spanning 200×200 μm. The same procedures described for the imaging and processing of the retina were used here for the brain. 25 μM Glutamic acid (prepared by adding Glutamic acid crystals to the external solution on the day of the experiment and preconditioned to physiological conditions in an incubator) was added to the dish at t=100 s (for fast imaging) and t=300 s (for high-resolution imaging).

The ADQ7WB (Teledyne SP Devices) digitizer can sample at 5 GS/s for two channels and has an onboard open FPGA. While the acquisition clock operates at 5 GHz for two channels, the FPGA clock operates at 312.5 MHz. Therefore, 16 samples are available for processing at each falling edge of the FPGA. Since SPEED needs three consecutive samples for detecting the local peak, two 16-bit shift registers are set up as the memory to remember the last two samples from the previous cycle. Every clock cycle of the FPGA utilizes 18 consecutive 16-bit analog samples per channel to derive 16 instances of 4-bit photon counts. To maintain the same data size through the bus for the downstream modules of the FPGA (until the sample-skip module), 4-packed copies of the photon counts are created such that the FPGA can be operated with a sample skip factor of 4. The 16-bit photocurrents are converted to 4-bit photon counts leading to a 4× data compression factor.

SPEED relies on finding the local peaks by comparing each digitized sample to its nearest neighbors on either side and comparing it to photon thresholds (five thresholds for HPD, two threshold values for PMT). If both conditions are satisfied, N photons (depending on the threshold) are assumed to have arrived at that sampling instant. After this, the photons within each laser period are coherently aligned and summed for all laser pulses in a pixel (for the 80 MHZ setup with hundreds of pulses per pixel) or a single line in a frame (for setups with lower repetition rates). The laser pulse is assumed to have occurred at the peak of this summed decay profile. All photons are aligned to this inferred laser pulse digitally and cumulated across the response of all laser pulses for the pixel and across frames to build the histogram for fluorescence decay. The lifetime values can be estimated using a curve fitting to an exponential or using phasor analysis. The latter was used throughout this example and was performed in real-time on a GPU.

Since the photon counts from neurons were weak, the decays from each pixel were binned for 8×8 superpixels and used to derive the intensity and lifetime values. Each pixel in the sample had approximately 2-10 fluorescent photons and the binning size was chosen to ensure sufficient photons for lifetime estimation in each super-pixel. The intensity and lifetime values from any superpixel with fewer than 70 photons were rejected for all further analysis. The MATLAB functions corrcoef( ), pca( ), kmeans( ), and fit ( . . . , . . . , ‘poly2’) were used for correlation coefficient calculation, for principal component analysis, for k-means clustering, and for fitting, respectively. The NAD(P)H and FAD intensities were normalized to the average intensity of each frame. The Ca²⁺ dynamics also normalized by subtracting and dividing by the average fluorescence intensity of the superpixel during the first 20 frames.

The supercontinuum-based OCT/OCM system had artifacts along the axial direction not corrected by traditional methods of OCT/OCM image reconstructions. Since existing algorithms were insufficient to correct this dispersion mismatch, a solution called DISCOTECA (DISpersion Correction Techniques for Evident Chromatic Anomaly) was devised, which also provided a universal paradigm for OCT/OCM reconstruction.

Since the average photon counts of the NAD(P)H and FAD channels were less than 2 photons per frame, all quantitative metrics were calculated after binning 16×16 pixels with an 8-pixel overlap; a minimum of thousand photons were used for calculating the fluorescence lifetime values. The birefringence images were binned using a circular mean algorithm. For 50 seconds after each optical excitation, the responses collected from each superpixel for each contrast were fit to a first-order polynomial function. The relative slope for each contrast following each stimulation was used as the input to a k-means clustering algorithm. The median responses of each cluster were visualized. All intensity values were normalized to the median intensity of each superpixel across all 1000 s before clustering. The value of k was chosen such that no two clusters had an absolute correlation coefficient greater than 0.7. Instead of calculating the slopes and intercepts after each excitation pulse, the slopes and intercepts were calculated for every 120-second duration.

The present disclosure has described one or more preferred embodiments. However, the invention has been presented by way of illustration and is not intended to be limited to the disclosed embodiments. It should be appreciated that many equivalents, alternatives, variations, and modifications, aside from those expressly stated, are possible and within the scope of the invention.

What is claimed is:

1. A pulse shaper comprising:
a diffraction grating configured to receive an incident light beam and to generate a spectrally separated light beam therefrom;
a collimator lens configured to receive the spectrally separated light beam and to generate a collimated light beam therefrom;
a two-dimensional (2D) spatial light modulator (SLM) encoded with 2D map of phase values including a phase function and an amplitude modulation function, the 2D SLM configured to receive the collimated light beam and to generate an amplitude-and-phase-modulated light beam therefrom; and
a controller, wherein the controller is configured to control a calibration of the pulse shaper based on a look-up table which maps input pixel values of the 2D SLM to output phase values over a wavelength range including a bandwidth of the collimated light beam.

2. The pulse shaper of claim 1, wherein the collimator lens is a cylindrical lens.

3. The pulse shaper of claim 1, wherein the phase function comprises a user-defined phase function of frequency.

4. The pulse shaper of claim 1, wherein the phase function is applied along a frequency axis of the 2D SLM.

5. The pulse shaper of claim 1, wherein the amplitude modulation function is applied along an axis orthogonal to an axis of the phase function on the 2D SLM.

6. The pulse shaper of claim 1, wherein the amplitude modulation function comprises a binary grating function of different values.

7. The pulse shaper of claim 1, wherein the amplitude modulation function and the phase function are independently designed and simultaneously implemented on the 2D SLM.

8. The pulse shaper of claim 1, further comprising a controller, wherein the controller is configured to control a calibration of the pulse shaper based on a look-up table which maps input pixel values of the 2D SLM to output phase values over a wavelength range including a bandwidth of the collimated light beam.

9. A microscopy system comprising:
a laser configured to output a first beam and a second beam;
a first optical system configured to receive the first beam, the first optical system comprising:
a first pulse shaper configured to shape a first component of the first beam in at least one of a spectral aspect or a temporal aspect, the first pulse shaper including a first diffraction grating, a first achromatic half-wave plate, a first lens, and a first two-dimensional (2D) spatial light modulator (SLM); and
a second optical system configured to receive the second beam.

10. The system of claim 9, wherein the laser includes a tunable output configured to output the first beam, and a fixed output configured to output the second beam.

11. The system of claim 9, wherein the first optical system further comprises a beam splitter configured to split the first beam into the first component and a second component.

12. The system of claim 11, wherein the first optical system comprises a first beam combiner configured to combine the shaped first component with the second component to generate a first combined beam.

13. The system of claim 9, wherein the first optical system further comprises a photonic crystal fiber configured to modify a bandwidth of the first component.

14. The system of claim 13, wherein the first optical system comprises a first optical delay line disposed between the first photonic crystal fiber and the first pulse shaper, the first optical delay line configured to delay the bandwidth-modified first component by an amount approximately equal to a pulse period of the first beam.

15. The system of claim 13, wherein a grating density of the first diffraction grating is based on at least one of a bandwidth of the bandwidth-modified first component and a width of an active area of the first 2D SLM.

16. The system of claim 13, wherein the first 2D SLM has been calibrated based on a first lookup table configured to map input pixel values to output phase values over a wavelength range including a bandwidth of the bandwidth-modified first component.

17. The system of claim 9, wherein the first beam is a Stokes beam and the second beam is a pump beam.

18. The system of claim 9, wherein the second optical system comprises:
a second pulse shaper configured to shape a third component of the second beam in at least one of a spectral aspect or a temporal aspect, the second pulse shaper including a second diffraction grating, a second achromatic half-wave plate, a second lens, and a second 2D SLM.

19. The system of claim 9, wherein the second optical system further comprises:
a beam splitter configured to split the second beam into the third component and a fourth component; and
a photonic crystal fiber configured to modify a bandwidth of the third component.

20. The system of claim 19, wherein the second optical system comprises a second beam combiner configured to combine the shaped third component with the fourth component to generate a second combined beam.

21. The system of claim 19, wherein the second optical system comprises a second optical delay line disposed between the second photonic crystal fiber and the second pulse shaper, the second optical delay line configured to delay the bandwidth-modified third component by an amount approximately equal to a pulse period of the second beam.

22. The system of claim 19, wherein a grating density of the second diffraction grating is based on at least one of a bandwidth of the bandwidth-modified third component and a width of an active area of the second 2D SLM.

23. The system of claim 19, wherein the second 2D SLM has been calibrated based on a second lookup table configured to map input pixel values to output phase values over a wavelength range including a bandwidth of the bandwidth-modified third component.

24. The system of claim 20, further comprising a third beam combiner configured to combine the first combined beam and the second combined beam to generate an output beam.

25. The system of claim 20, wherein a pulse width of the first combined beam is substantially equal to a pulse width of the second combined beam, and a frequency bandwidth of the first combined beam is substantially equal to a frequency bandwidth of the second combined beam.

26. The system of claim 24, further comprising:
a stage configured to support a sample for microscopy;
an objective lens configured to focus the beam onto the sample; and
a mirror and lens system configured to direct the output beam to the sample.

27. The system of claim 26, wherein the mirror and lens system includes a galvanometer mirror.

28. The system of claim 26, further comprising a photodetector configured to capture an image of the sample based on coherent anti-Stokes Raman scattering of the output beam by the sample.

29. The system of claim 28, further comprising a processing system configured to remove a background from the image.

30. A method of microscopy comprising:
outputting a first laser beam to a first optical system and a second laser beam to a second optical system;
by a first beam splitter of the first optical system, splitting the first beam into a first component and a second component;
by a first photonic crystal fiber of the first optical system, modifying a bandwidth of the first component;
by a first pulse shaper of the first optical system, shaping at least one of a spectral aspect or a temporal aspect of the first component;
by a first beam combiner of the first optical system, combining the shaped first component with the second component to generate a first combined beam;
by a second beam splitter of the second optical system, splitting the first beam into a third component and a fourth component;
by a second photonic crystal fiber of the second optical system, modifying a bandwidth of the third component;
by a second pulse shaper of the second optical system, shaping at least one of a spectral aspect or a temporal aspect of the third component;
by a second beam combiner of the second optical system, combining the shaped third component with the fourth component to generate a second combined beam; and
by a third beam combiner, combining the first combined beam with the second combined beam to generate an output beam.

31. The method of claim 30, further comprising:
directing the output beam to a sample; and
capturing an image of the sample based on coherent anti-Stokes Raman scattering of the output beam by the sample.
